(19) United States
(12) Patent Application Publication
(10) Pub. No.: US 2025/0229875 A1
(43) Pub. Date: Jul. 17, 2025

(54) Maritime Tactile Communication

(71) Applicant: Honda Motor Co., Ltd., Tokyo (JP)

(72) Inventors: Matti Krüger, Offenbach (DE); Tim Sennhenn, Offenbach (DE)

(73) Assignee: Honda Motor Co., Ltd., Tokyo (JP)

(21) Appl. No.: 18/412,999

(22) Filed: Jan. 15, 2024

(51) Int. Cl. B63B 49/00; G01C 21/20

(52) U.S. Cl. CPC B63B 49/00; G01C 21/20

(57) ABSTRACT

The present disclosure relates to a computer-implemented method for assisting a person in operating a marine vessel. The method comprises steps of obtaining information on an environment of the marine vessel to determine at least one event, state or entity; acquiring position and orientation information of the marine vessel, and determining a relative position of the determined event or object, relative to the marine vessel, determining first spatial signaling information based on the relative position, and acquiring position and orientation information of a tactile interface device comprising actuators arranged in contact with the assisted person; and computing second spatial signaling information by converting the first spatial signaling information based on the orientation information of the marine vessel and the tactile interface device, and generating control information for the tactile interface device and outputting, via the tactile interface device, the computed second spatial signaling information to the assisted person.

### TECHNICAL FIELD OF THE DISCLOSURE

The disclosure relates to the general field of assistance systems, in particular maritime assistance systems. In particular, a method for controlling a maritime tactile human machine interface of a maritime assistance system, a corresponding system, and a tactile interface device of a maritime assistance system are disclosed.

### TECHNICAL BACKGROUND

Marine navigation refers to the task of steering a vessel from a starting point to a destination in an efficient and responsible manner, avoiding the danger present on water, using a wide range of knowledge including physics, astronomy, oceanography, and cartography, for example. Marine navigation and many of the tasks performed by crewmembers on board of a marine vessel require a timely perception of elements in the environment, which might have an impact on the course of the marine vessel and the performance of the task. Perception in time enables a smooth integration of the relevant elements into a decision process how to proceed in order to achieve a set target.

The perception in the maritime environment may be impaired by a wide variety of factors including poor visibility due to weather, e.g., fog, rain, or snow, poor illumination, e.g., darkness, or, by the opposite, sun glare. Environmental effects including reflection on the water surface, water clarity, and visual distortions for elements below the water surface may adversely affect visibility further. The vessel shape of the own vessel, or other vessels, cargo or waves may obstruct vision towards elements in the environment that influence the further evolvement of the current scene.

The timely perception of relevant elements in the environment of the vessel and their integration into the decision-making process is also highly dependent on user focus: the operator of a marine vessel may carry out other tasks temporarily in addition to navigating the vessel. In such situations, a situational awareness of the operator may be particularly low, and the operator may spend close to no focus on the environment even though the vessel may still move, or also assumed static may still be subject to currents or winds, and move in the environment, or represent an obstacle to the intended route of other vessels.

A further aspect is disorientation of the operator. In open water far from the coast, reference points for orientation and supporting navigation generally lack. This may result in deviations from a set course due to wind or currents acting upon the marine vessel, which may result in a gradual deviation from the intended course without the operator noticing it.

There exist technical approaches to assist the human operator in operating the maritime vessel.

The maritime hazard detection system disclosed in patent AU 2013251283 B2 deploys an unmanned aquatic surface vehicle under control of a control station on board of a marine vessel for detecting and locating subsurface, surface or above-surface hazards ahead in a direction of travel of the marine vessel. Hazard data associated with a detected hazard is transmitted to a remote receiver at the control station, and a display may visually present information about the detected hazards to an operator.

Assistance systems with a visual output of assistance information on a display may supply the operator with additional information on the environment of the marine vessel. However, using purely visual assistance systems may generate problems of its own. For example, the assistance system competes with other visual requirements or other stimuli during navigation, e.g., monitoring the environment or talking to other people on board the marine vessel. In addition, visual assistance systems may themselves suffer from visibility issues and therefore fail to provide an improvement, e.g., for an impaired visibility due to sunlight.

Another aspect concerns the often highly dynamic nature of the maritime environment. Other objects and their locations are often mobile to varying degrees, e.g., other vessels on intersecting courses, another vessel or the path of marine wildlife that the marine vessel is intended to follow or avoid. Such moving entities in the environment of the marine vessel result in an almost continuous change in the intended trajectory of the marine vessel. This amplifies the described above issues of visual assistance systems because the need for visual confirmation on the display of the assistance system and the need for monitoring of the actual environment both increase.

The aforementioned aspects regarding an assistance of a person in operating a marine vessel in the environment in a safe and efficient manner are addressed by the present disclosure.

### SUMMARY

A computer-implemented method for assisting a person in operating a marine vessel according to an aspect comprises: obtaining information on an environment of the marine vessel, and determining, from the obtained information on the environment, at least one event, state or entity for which information on the location of the event, state or entity shall be communicated to the assisted person. The method proceeds with determining a relative position of the determined at least one event, state or entity, relative to the marine vessel. First spatial signaling information is determined based on the relative position; relative position information and relative orientation information of a tactile interface device is acquired, which is information on a position and information on the orientation of the tactile interface device relative to the marine vessel. The tactile interface device comprises a plurality of actuators that can be brought into contact with the assisted person. The method proceeds with computing second spatial signaling information by converting the first spatial signaling information based on the relative orientation information and relative position information of the tactile interface device, generating control information for the tactile interface device, and outputting, via the tactile interface device, the computed second spatial signaling information to the assisted person.

### BRIEF DESCRIPTION OF THE DRAWINGS

The aspects and implementation of the present disclosure will be explained in the following description of specific embodiments in relation to the enclosed drawings, in which:

FIG. 1 shows a flowchart providing an overview over a computer-implemented method for assisting a person in operating a marine vessel according to an embodiment;

FIG. 2 shows a block diagram illustrating modules and signals of an assistance system for assisting a person in operating a marine vessel according to an embodiment;

FIG. 3 shows a block diagram illustrating the structural modules of an embodiment of a tactile interface device together with an exemplary arrangement in a wearable device;

FIG. 4 provides an overview of an application scenario for the assistance system for assisting a person in operating a marine vessel that operates in a plurality of modes and includes an automatic mode selection process according to an embodiment;

FIG. 5A shows a view of the application scenario for the assistance system that operates in a general alerting mode and a navigation mode according to an embodiment;

FIG. 5B shows a view of the application scenario for the assistance system that operates in a disturbing forces mode according to an embodiment;

FIG. 5C shows a view of the application scenario for the assistance system that operates in a man-over-board mode according to an embodiment;

FIG. 5D shows a view of the application scenario for the assistance system that operates in a right of way assistance mode according to an embodiment;

FIG. 5E shows a view of the application scenario for the assistance system that operates in a navigation-channel guidance mode and in a docking mode according to an embodiment;

FIG. 6 shows a view of an application scenario for the assistance system that has an extended tactile signaling capability and a respective actuator arrangement according to an embodiment;

FIG. 7 shows a view of an application scenario for the assistance system that has the extended tactile signaling capability and further provides roll angle, yaw angle, and pitch angle compensation according to an embodiment;

FIG. 8 shows a view of the application scenario for the assistance system that has the extended tactile signaling capability and further provides roll angle, yaw angle, and pitch angle compensation in a further embodiment;

FIG. 9 shows a birds-eye view of an application scenario for the assistance system that operates in a navigation-channel guidance mode or docking mode according to an embodiment;

FIG. 10 shows a birds-eye view of an application scenario for the assistance system that covers a trailer-loading scenario for the maritime vessel;

FIG. 11 shows a birds-eye view of an application scenario for the assistance system that covers a man-over-board scenario for the maritime vessel;

FIG. 12 shows a birds-eye view of an application scenario for the assistance system that operates in the bad-weather avoidance mode in an application scenario for the maritime vessel;

FIG. 13 illustrates the assistance system operating in the right-of-way assistance mode;

FIG. 14 shows example scenarios of the assistance system operating in the disturbing-forces assistance mode illustrating respective exemplary encodings for the tactile stimulation output by the tactile interface device;

FIG. 15 shows a basic scenario for determining stimulus encodings in a maritime scenario for the assistance system operating in the disturbing-forces assistance mode;

FIG. 16 shows a specific scenario for determining stimulus encodings in a maritime scenario involving local currents for the assistance system operating in the disturbing forces assistance mode providing further implementation details;

FIG. 17 shows a specific scenario for determining stimulus encodings in a maritime scenario involving winds for the assistance system operating in the disturbing-forces assistance mode providing further implementation details;

FIG. 18A illustrates a scenario for determining stimulus encodings in a maritime scenario involving waves;

FIG. 18B illustrates a further scenario for determining stimulus encodings in a maritime scenario involving waves;

FIG. 19 illustrates a further scenario for determining stimulus encodings in a maritime scenario involving waves for the assistance system illustrating implementation details;

FIG. 20 illustrates a docking scenario of smaller vessel docking at a larger vessel in a maritime scenario involving waves;

FIG. 21 illustrates inference levels and response states in a tactile interface device useful;

FIG. 22 depicts an exemplary scenario of route navigation with the assistance system illustrating specific implementation details;

FIG. 23 depicts an exemplary scenario of a general alert stimulation in the assistance system illustrating specific implementation details;

FIG. 24 depicts an exemplary scenario of integrating AIS system signals in an embodiment of the assistance system;

FIG. 25 illustrates specific obstacle encodings and directional computation for the tactile interface device and the maritime vessel in an embodiment of the assistance system.

The description of figures uses same references numerals for same or corresponding elements in different figures. The description of figures dispenses with a detailed discussion of same reference numerals in different figures whenever considered possible without adversely affecting comprehensibility.

### DETAILED DESCRIPTION

The computer-implemented method according to the first aspect of the disclosure has a marine tactile human-machine interface for transferring vessel-related and environment-related information to a person that operates the marine vessel. The purpose of the information transfer is to support the operators of the marine vessel in tasks related to vessel control and providing vessel related information, including, e.g., navigating, docking, avoiding obstacles, adherence to regulations, accounting for weather conditions such as current and wind, achieving energy efficiency when operating the marine vessel.

The information on the location of the event, a state or entity relative to the assisted person that shall be communicated to the assisted person is converted for being output in a tactile stimulation in a tactile signal, or in other forms of tactile stimuli such as pressure. Tactile signals may encode the information in signals of different amplitudes, strengths, frequencies, temporal and spatial patterns. The tactile interface device uses modalities independent from the usual visual and auditory modalities of conveying information. The tactile interface device compensates for shortcomings of reliance on the visual and auditory modalities in difficult conditions, e.g., in low visibility or noisy environments.

The tactile interface device may comprise a plurality of actuators that are integrated into wearables. In particular, personal flotation devices widely used in the maritime environment or even mandatory, including, e.g., life vests, life preservers, jackets, but it also can be mounted fixed in place for applications that require less personal movement e.g.: on a chair often arranged at the steering position of a vessel, whether it is a large transport ship or a small motor yacht. Hats, leg-and wrist straps (e.g., within a watch) can also be used to integrate the actuators. An advantage of interfacing with the torso is that it is easy to communicate directions relative to the body while other body parts may require more complex measurements, conversions or conventions for direction encoding. Communication relative to the head using, e.g., a hat with integrated actuators might be perceived as similarly intuitive as communication relative to the body and be preferable for some embodiments.

The tactile interface device may be combined with various additional hardware including sensors and other sources of information and is applicable to transfer information in various types of data.

Therefore, signals provided by the tactile interface device may, e.g., convey information that relates to objects (entities) in the environment of the marine vessel, such as spatial or temporal distances to static or moving obstacles or to target locations. It may also contain information about entities, events, states or predictions that relate to the targets of the vessel-operator, or a governing entity such as current or predicted deviations from a target trajectory of the marine vessel in the linear and rotational direction. Such targets can also include the adherence to regulations and customs for marine traffic and may take variable factors such as local rule variations and weather conditions into account based on information from multiple sensors or other connected resources.

By an inclusion of sensors that yield information about the state of the user of the tactile interface device, such as location and orientation relative to the marine vessel or surrounding elements, the tactile interface device may achieve a direct alignment between tactile stimulus location and the direction associated with a conveyed message (e.g., obstacle direction), even when the assisted person is moving around on the marine vessel.

The dependent claims define advantageous embodiments of the disclosure.

The computer-implemented method according to an embodiment, wherein the determined at least one entity includes at least one of another marine vessel, a person in the water, above or below the water level, a moving wave, a wind gust, a marine current, a tidal current, and a static or moving object in the water or below the sea level. Such a static object may specifically be a quay wall, a buoy or a dock that needs to be approached in a docking situation.

In an embodiment of the computer-implemented method, the determined at least one event includes at least one of a predicted collision with the determined object, a predicted deviation from a planned trajectory of the marine vessel, a determined state of the marine vessel or another marine vessel.

In an embodiment of the computer-implemented method, the determined at least one state includes at least one of a predicted deviation from a planned trajectory of the marine vessel, a determined state of the marine vessel or of another marine vessel.

The computer-implemented method according to an embodiment includes determining the state of the marine vessel and at least one other vessel based on right-of-way rules for marine traffic or based on marine customs.

In an embodiment of the computer-implemented method, the method includes determining contextual information for determining the state of the marine vessel or another vessel, wherein the determined contextual information includes at least one of weather information, vessel-related information, topography-related information, information on topography of sea floor, information on maritime infrastructure, event related information.

The computer-implemented method according to an embodiment includes outputting, via the tactile interface device, the computed second spatial signaling information to the assisted person including communicating the direction or location of the determined at least one event, state or entity relative to the assisted person. The direction for location is communicated using a tactile stimulus position on a body of the assisted person.

The computer-implemented method according to an embodiment includes outputting, via the tactile interface device, the computed second spatial signaling information to the assisted person including communicating an encoded tactile representation of the determined at least one event, state or object in the tactile stimuli output to a body of the assisted person.

In an embodiment of the computer-implemented method, the encoded tactile representation includes in at least one first tactile characteristic of the tactile stimuli a predicted impact and in at least one second characteristic of the output tactile stimuli the encoded determined at least one event, state or object.

An embodiment of the computer-implemented method comprises determining at least two different events, states or entities determined from the observation of the environment which are to be communicated to the assisted person, and automatically selecting, based on at least one selection criterion, at least one of the at least two different events, states or entities to the assisted person.

In an embodiment of the computer-implemented method, the at least one selection criterion includes the assisted person boarding the marine vessel, and in case of determining that the assisted person boards the marine vessel, automatically switching from communicating the second spatial information including a route or direction towards the marine vessel via the tactile interface device to communicating the selected events, states or entities different from the marine vessel.

In the computer-implemented method according to an embodiment, the at least one selection criterion includes the assisted person leaving the marine vessel, and in case of determining that the assisted person leaves the marine vessel, automatically switching from communicating the selected events, states or entities different from the marine vessel via the tactile interface device to communicating the second spatial information including a direction towards the marine vessel to the assisted person.

An embodiment of the computer-implemented method comprises automatically selecting, based on at least one selection criterion, including selecting between different modes of assistance, and the different modes include at least two of a general alerting mode, a route navigation mode, a bad weather avoidance mode, a disturbing-forces assistance mode, man or object overboard mode, a right-of-way assistance mode, a navigation channel guidance mode, and a docking mode, and at least one of the modes of assistance is active at a given time.

The computer-implemented method according to an embodiment includes the tactile interface device arranging the plurality of tactile actuators in a three-dimensional grid extending in a vertical direction in addition to two horizontal directions when worn by the assisted person, and the method comprises, in the step of computing the second spatial signaling information by converting the first spatial signaling information, compensating for at least one of a roll angle, pitch angle and yaw angle of the marine vessel.

In a second aspect of the disclosure, a system for assisting a person in operating a marine vessel comprises at least one sensor configured to obtain information on an environment of the marine vessel, a processor configured to determine, from the obtained information on the environment, at least one event, entity or state for which information including at least a direction or location of the event, entity or state is to be signaled to the assisted person. The processor is further configured to determine a relative position of the determined at least one event or object, relative to the marine vessel, to determine first spatial signaling information based on the relative position, and to acquire position and orientation information of a tactile interface device. The tactile interface device comprises a plurality of actuators arranged in contact with the assisted person. The processor is configured to compute second spatial signaling information by converting the first spatial signaling information based on the orientation information of the marine vessel and the orientation information of the tactile interface device. A controller of the tactile interface is configured to generate control information for the tactile interface device and to output, via the tactile interface device, the computed second spatial signaling information to the assisted person.

In a second aspect of the disclosure, a tactile interface device for communicating information to a person in a maritime environment comprises a communication interface configured to obtain spatial signaling information, a controller configured to generate control information based on the obtained spatial signaling information, a plurality of tactile actuators arranged in contact with a body of the assisted person and configured to output based on the generated control information, the spatial signaling information to the assisted person.

In an embodiment of the tactile interface device, the tactile interface device is a wearable device.

The wearable device of an embodiment is a personal flotation device, in particular a life jacket or a life preserver.

The wearable device is a belt worn by the assisted person.

The tactile interface device according to an embodiment is integrated into a seat of the marine vessel.

The plurality of tactile actuators of the tactile interface device according to an embodiment is arranged in a three-dimensional grid extending in a vertical direction in addition to two horizontal directions when worn by the assisted person.

Thus, the tactile interface device has an improved capability to provide information on relevant aspects in the environment that includes objects and entities below the sea surface. Additionally, the information presentation may be corrected for waves and heavy swell, which is particularly advantageous for application scenarios involving small boats as the maritime vessel operating in a sea environment near coasts, for example.

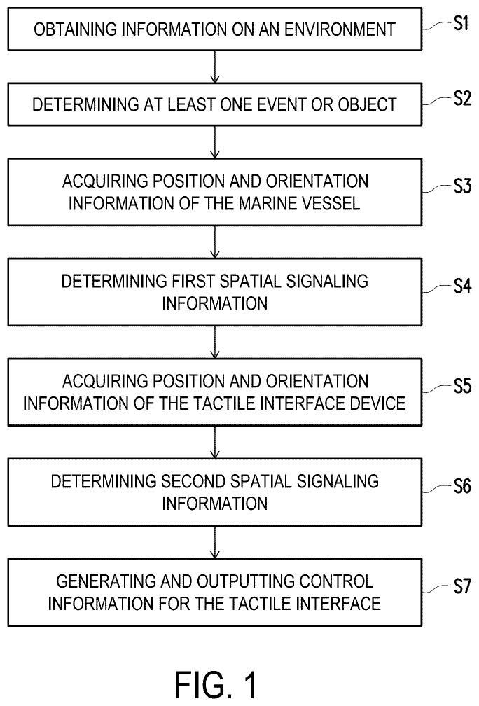

FIG. 1 shows a flowchart providing an overview over a computer-implemented method for assisting a person in operating a marine vessel according to an embodiment.

The computer-implemented method is implemented in an assistance system that assists a person in operating a marine vessel. The assisted person might be actually navigating the marine vessel, e.g. as captain or helmsman. The assisted person may be a crewmember of the marine vessel, including, e.g. a bowman on a sailing boat or a deckhand on a large cargo ship or cruise ship. In some application scenarios, the assisted person may be a passenger on board of the marine vessel.

The method assists the person in performing a task or a plurality of tasks on the marine vessel. The marine vessel may be a submersible or a submarine having at least the additional capability to operate below the sea surface, or a surface vessel. The maritime vessel may be an exclusively motor-driven vessel or a vessel having at least in addition alternate propulsion means including sails or kites, for example. The maritime vessel may be small boat operated by a single crewmember having to cope with a variety of tasks simultaneously or a large ship, whose crewmembers have specific and specialized tasks, but also require a certain degree of awareness on the events in the environment or states of the maritime vessel. The maritime vessel may be designed as a fishing vessel, a cargo vessel, a ferryboat, a tugboat, a working boat, a cruise liner, a recreational boat, a research vessel, in order to name some examples.

The support of the assisted person may extend to the plurality of tasks that are included in operating the vessel on deck or below deck of the vessel. The assistance system may offer a plurality of functionalities, each functionality or functional mode of the assistance system addressing a specific task and supporting the assisted person in achieving a specific target or subtask of operating the maritime vessel in the maritime environment. The assistance system may run one functionality or functional mode at a time and select the active mode from a plurality of active functional modes based on a selection criterion automatically.

Alternatively or additionally, the assistance system may operate in plural functional modes simultaneously.

Alternatively or additionally, the assisted person may select the at least one functional mode in which the assistance system is to operate by a respective input.

The computer-implemented method includes the basic method steps illustrated by the flowchart in FIG. 1. The method starts with step S1 of obtaining information on an environment of the marine vessel.

The environment of the marine vessel may in particular be a maritime environment surrounding the marine vessel. The information may be acquired by at least one sensor, e.g., including an optical sensor, a RADAR sensor, a LIDAR sensor, a SONAR sensor and a contact sensor. The information may be acquired by a sensor positioned on board of the marine vessel or externally to the marine vessel and communicated to the marine vessel via a communication link, e.g. via wireless transmission.

In step S2, the method determines, from the obtained information on the environment, at least one event, state or entity for communication to the assisted person.

The determined at least one entity may include at least one of another marine vessel, a person in the water or below the sea level, a moving wave, a wind gust, a marine current, a tidal current, and a static or moving object in the water or below the sea level. A moving object may include a shoal of fish.

The determined at least one event may include a predicted or occurred collision with a determined object in the environment, a predicted deviation from a planned trajectory of the marine vessel, a determined state of the marine vessel or another marine vessel.

The determined state of the marine vessel and at least one other vessel may include a state of sails of the marine vessel or the at least one other vessel, or a course or a right of way with regard to the at least one other vessel based on a right-of-way rules for marine traffic or based on marine customs.

In step S3, the method acquires position and orientation information of the marine vessel. The absolute position and orientation of the marine vessel is required in the case where an absolute location of an event, state or object is communicated to the marine vessel and, based on such received information, the relative position of the event, state or entity, which means relative to the marine vessel, is to be determined.

Position and orientation information of the marine vessel may be provided by a positioning system of the marine vessel, e.g. including a navigation satellite system (satnav system), a global navigation satellite system (GNSS), the GPS system, GLONASS system, BeiDou navigation satellite system, the Galileo system, or a regional navigation satellite system, e.g. the quasi-zenith satellite system (QZSS) or the Indian regional navigation satellite system (IRNSS), or a high precision positioning system like RTK GPS (real time kinematic GPS).

The method proceeds in step S4 with determining a relative position of the determined at least one event, state or entity, relative to the marine vessel.

In step S4, the method determines the relative position based on the information obtained from the environment obtained in step S1, and based on the position and orientation of the marine vessel determined in step S3.

The method then determines in step S5 first spatial signaling information based on the relative position of the determined at least one event, state, or object relative to the marine vessel.

In step S6, the method acquires relative position and relative orientation information of a tactile interface device 50. The tactile interface device 50 comprises a plurality of actuators 17 arranged in contact, in particular in physical contact with the body or body parts of the assisted person.

In step S7, the method computes second spatial signaling information by converting the first spatial signaling information based on the relative orientation information of the marine vessel and the relative position information of the tactile interface device 50. Step S7 ensures that the second signaling information includes information location or direction of the event, state or entity to be communicated via the tactile interface device 50 has the correct direction with regard to the current position and orientation of the assisted person in the environment, independent of the actual orientation of the marine vessel. This is independent from a movement of the assisted person, and may also take into regard movement of the marine vessel in the environment, e.g. varying pitch angles, yaw angles, and roll angles of the marine vessel. The second signaling information will therefore be communicated with a correct bearing of the determined entity, event or state relative to the assisted person. Such a two-step determination of the position information on the entity, event or estate is specifically required for marine applications, because of the fact that the assisted person will regularly change its position and orientation on board.

In step S8 following to step S7, the method generates control information for the tactile interface device 50 based on the second signaling information, and outputs, via the tactile interface device 50, the computed second spatial signaling information to the assisted person. The tactile interface device outputs the second spatial signaling information by a tactile stimulation of the assisted person by controlling the actuators 17 of the tactile interface 50 by the generated control information.

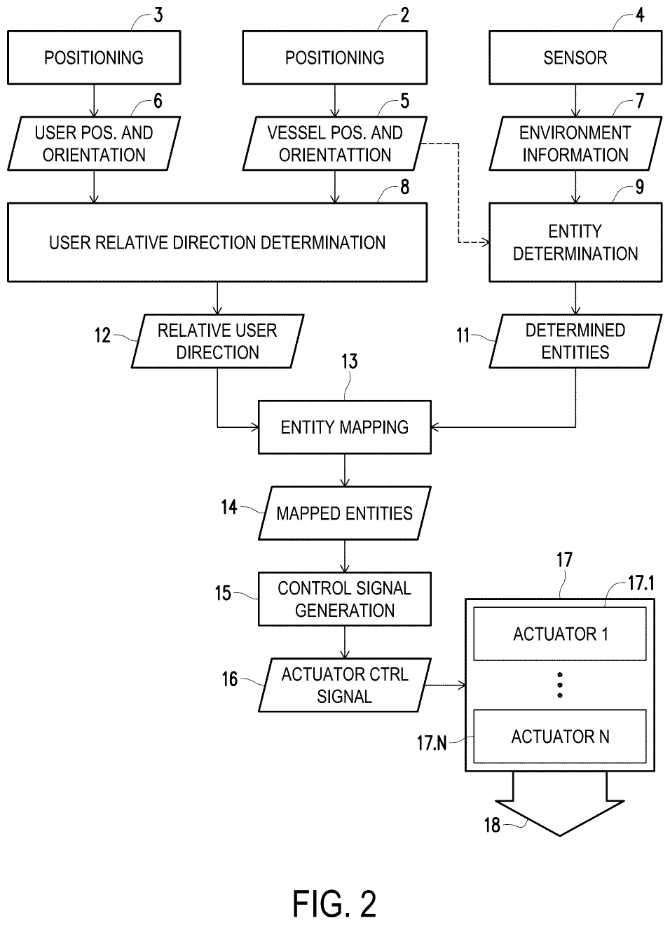

FIG. 2 shows a block diagram illustrating modules and signals of an assistance system 1 for assisting a person in operating a marine vessel according to an embodiment.

The assistance system 1 comprises at least one sensor 4 configured to obtain information (environment information 7) on the environment of the marine vessel. It is to be noted that the term “sensor” covers any technique capable of receiving information on the environment. This may even include a communication system for receiving communication signals transmitting information on objects physically sensed by a physical sensor external from the marine vessel.

Advantageously, the assistance system 1 obtains position and orientation information 5 from at least one positioning system, e.g. including a compass 2 and further means for determining position and orientation of the marine vessel.

The assistance system 1 further acquires relative position information and relative orientation information of the tactile interface device 50. For example, the tactile interface device 50 includes a compass 3 and further means for determining relative position and relative orientation of the tactile interface device 50. The tactile interface device 50 may be a wearable device that is worn by the assisted person. Hence, the acquired relative position information and relative orientation information of the tactile interface device 50 worn by the assisted person corresponds to position and orientation of the assisted person or of the assisted person's respective body part at which the device is worn (user position and orientation information 6).

At least the Marine vessel position and orientation information 5 is absolute position and orientation information in a global coordinate system provided by the vessel positioning system 3. The user position and orientation information 6 can be an absolute position and orientation information in a global coordinate system of the positioning system 3 of the tactile interface device 50, but it is also possible to obtain position and orientation information of the tactile interface device 50 relative to the vessel. This can be achieved by an optical tracking system installed on the vessel. The diagram in FIG. 2 however, shows an embodiment in which the position and orientation of the user wearing the tactile interface device 50 is determined as absolute information, which is the basis for determining the relative information as described below.

The assistance system 1 comprises at least one processor. The processor may be implemented using at least one microcontroller or signal processor with associated memory, the at least one processor running software that implements a plurality of functions by respective software modules. The processor may in particular implement the user-relative direction determination module 8, an entity determination module 9, an entity-mapping module 13, and a control-signal generation module 15.

In particular, the processor is configured to determine, from the obtained information (environment information 7) on the environment, at least one event, entity or state to be signaled to the assisted person in the entity determination module 9. The entity determination module 9 provides information 11 on the determined entity or entities, e.g., on the at least one event, entity or state to be signaled to the assisted person to the entity mapping module 13. The information 11 on the determined entities further includes information on a relative position of the determined at least one event or object, relative to the position and orientation of the marine vessel. The information 11 on the determined entities includes information on a relative position of the determined at least one event or entity in a vessel-based coordinate system, which means relative to the position and orientation of the marine vessel. This information 11 corresponds to first spatial signaling information.

The user-relative direction determination module 8 may obtain the vessel position and orientation information 5 and an absolute user position and orientation information 6 and determines a relative user position and relative orientation in a coordinate system of the marine vessel from the vessel position and orientation information 5 and the user position and orientation information 6 in the absolute coordinate system. The user-relative direction determination module 8 provides the determined relative user position and relative orientation in a coordinate system of the marine vessel in the relative user position and direction information to the entity-mapping module 13. The entity mapping module 13 performs a mapping process for mapping the information 11 on the determined entities from the vessel related coordinate system to a coordinate system centered in the assisted person based on the relative user position and direction information 12 provided by the user-relative direction determination module 8. The entity-mapping module 13 outputs the mapped information 14 on the determined entities in the coordinate system centered on the assisted person. The mapped information 14 on the determined entities in the coordinate system centered on the assisted person wearing the tactile interface device 50 corresponds to second spatial signaling information. The second spatial signaling information is information on a direction towards or a position of the determined event, state or entity in the coordinate system centered on the tactile interface device 50 and therefore in a coordinate system centered on the assisted person.

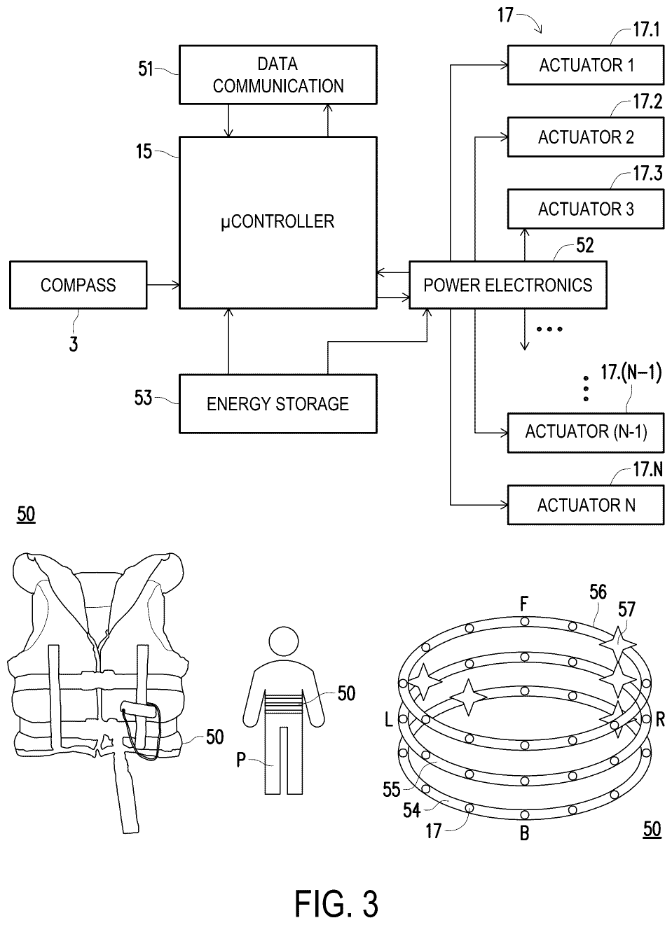

The entity-mapping module 13 outputs the mapped information 14 on the determined entities in the coordinate system centered on the assisted person to a controller 15 of the tactile interface 50 that is configured to generate the control information for the tactile interface device 50. The controller 15 outputs an actuator control signal 16 including the control information and controls the tactile stimulation 18 of the assisted person by the actuators 17 of tactile interface device 50. The tactile stimulation 18 of the assisted person by the plurality of actuators 17 bases on the computed second spatial signaling information with the coordinate system centered on the assisted person. The tactile interface device 50 comprises the plurality of actuators 17 arranged in contact with the assisted person and is discussed in more detail with reference to FIG. 3.

FIG. 3 shows a block diagram illustrating the structural modules of an embodiment of a tactile interface device 50 together with an exemplary arrangement in a wearable device.

The block diagram of FIG. 3 displays structural elements of the tactile interface device 50. Generally, the tactile interface device 50 provides the capability to transfer information using a tactile stimulation 18 of the assisted person. The tactile interface device 50 comprises a communication system 51 configured for data communication. The communication system 51 may perform wired or wireless communication. The communication system 51 is an interface to receive at the tactile interface device 50 a data signal representing the second communication information for transfer to the assisted person. The communication system 51 provides the obtained second communication information to the controller 15. The controller 15 controls the power electronics 52 of the tactile interface device 50 via the actuator control signal 16. The power electronics 52 control a power transfer from a power source to individual actuators 17.1, 17.2, 17.3, . . . , 17. (N-1), 17.N. The actuator control signal 16 may in particular include information that defines, which actuators 17.1, 17.2, 17.3, . . . , 17. (N-1), 17.N of the plurality of actuators 17 are driven by the power electronics 52.

The tactile interface device 50 of FIG. 3 includes a number N of actuators 17 that are connected individually with the power electronics 52 of the actuator device 50.

The tactile interface device 50 may include an energy storage 53 for storing energy and providing electric power supply to the actuators 17 via the power electronics 52, and for further electronic and electric consumers of the tactile interface device 50. Using an energy storage device 53 for a mobile power supply of the tactile interface device 50 in combination with a wireless communication system 51 enables to design a tactile interface device 50 that does not restrict the free movement of the assisted person around the marine vessel. Simultaneously, the computer-implemented method ensures a continuously possible tactile communication of relevant information to the assisted person.

The tactile actuator device 50 arranges the plurality of actuators 17 in direct contact with the body of the assisted person P. In the lower left part of FIG. 3, an exemplary embodiment of a spatial arrangement of the plurality of actuators 17 of the tactile interface device 50 is illustrated. The depicted embodiment arranges the actuators 17 in three parallel planes 54, 55, 56, one circular arrangement of tactile actuators 17 on each of the parallel planes 54, 55, 56. In the arrangement shown in FIG. 3, the actuators 17 on each of the planes are arranged with an equal distance to each on the neighboring actuators 17. The spatial arrangement of actuators of FIG. 3 may be achieved by integrating the actuators 17 into a garment worn by the assisted person P as indicated in the lower center part of FIG. 3. The arrangement of the actuators 17 in the displayed manner provides the capability to direct a direction-dependent tactile stimulation to the torso of the assisted person P. The controller 15 may, by activating the respective actuators 17 alone or in groups of actuators 17, provide the tactile stimulation 18 in a targeted manner to the assisted person. The assisted person is able to discriminate whether the tactile stimulation 18 is to the front F or to the rear R, to the left L or right R, is in the upper circle of actuators 17 situated on the top plane 56, in the mid-level plane 55 or the lower plane 54 of the spatial arrangement of actuators 17. Accordingly, dependent on the chosen encoding of the second spatial information into the actuator control signal 16, the tactile stimulation by the active actuators 57 pushes or pulls the attention of the assisted person to the intended horizontal direction, and possibly to elevation or depression into a vertical direction.

The discussed spatial arrangement of the tactile actuators 17 in three planes and on circles in each plane with equal distances between the actuators 17 is one specific example. The number of planes and the distances between the actuators and the distance between the planes 54, 55, 56 may differ, e.g. dependent on the spatial resolution capabilities with respect to tactile stimulation of the human and the requirements of the particular application.

Due to their small size, the actuators 17, the controller 15 and the further peripheral elements of the tactile actuator device 50 can be integrated into a personal flotation device providing swimming support to the assisted person. The personal flotation device may be a life preserver, life jacket or life vest mandatory or a least recommended for wear in many maritime scenarios. Integration of a tactile modality provided by the tactile interface device 50 opens a wide variety of possible application scenarios, which will be discussed with reference to further figures along with further advantageous aspects and embodiments.

Alternative embodiments integrate the tactile interface device 50 into a belt or a harness worn by the assisted person. Both the personal flotation device the harness fulfill further roles in the maritime environment and therefore particularly advantageous for implementing the tactile interface device 50.

Further alternative embodiments integrate the tactile interface device 50 into a seat, which is often arranged in a cockpit of smaller boat or on a bridge of a larger vessel at least for the helmsman.

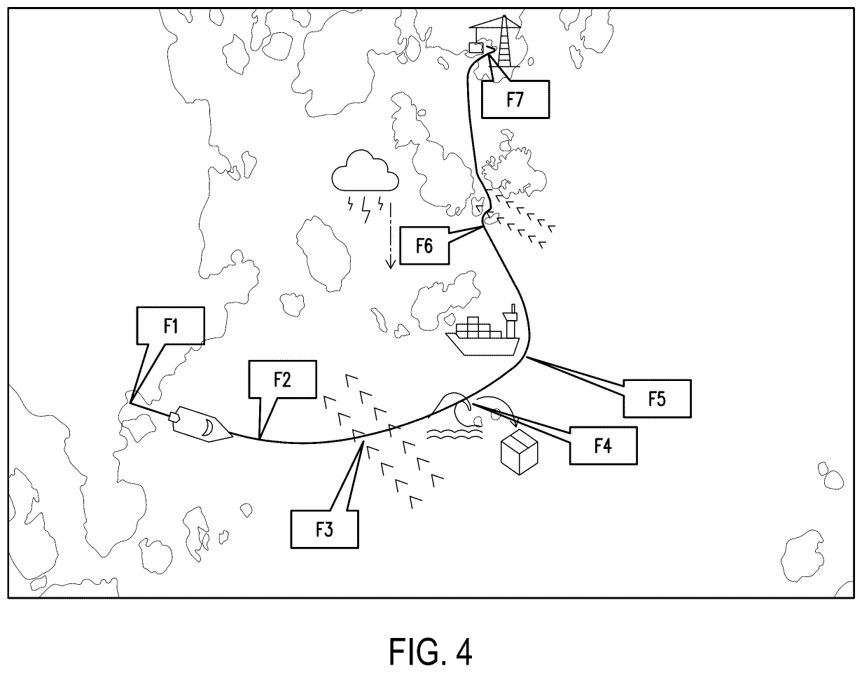

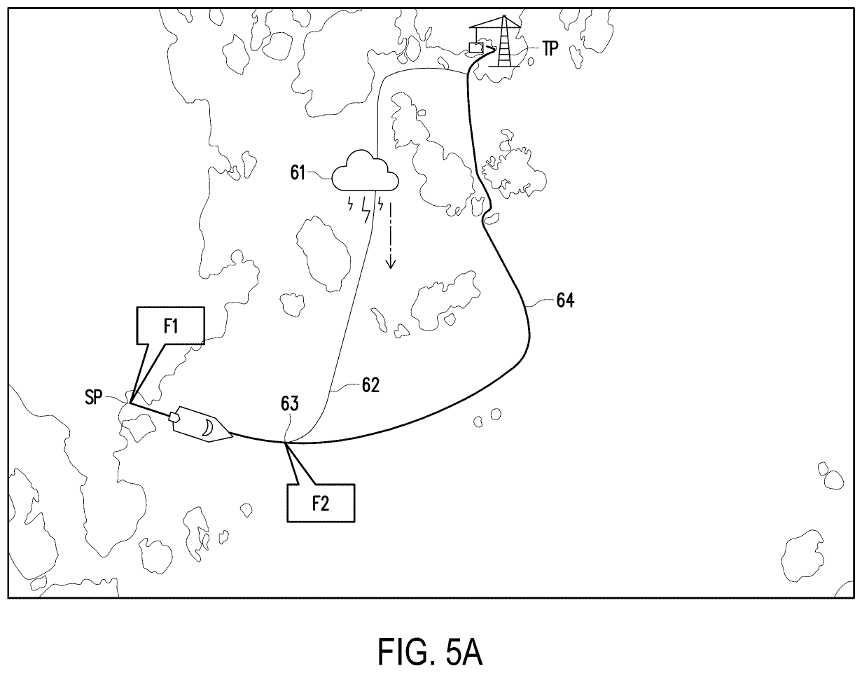

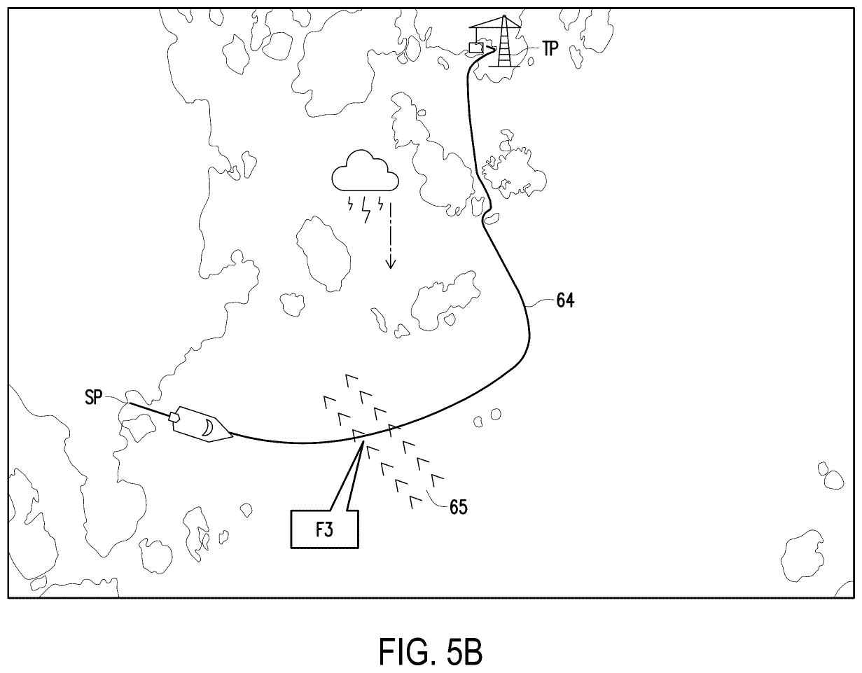

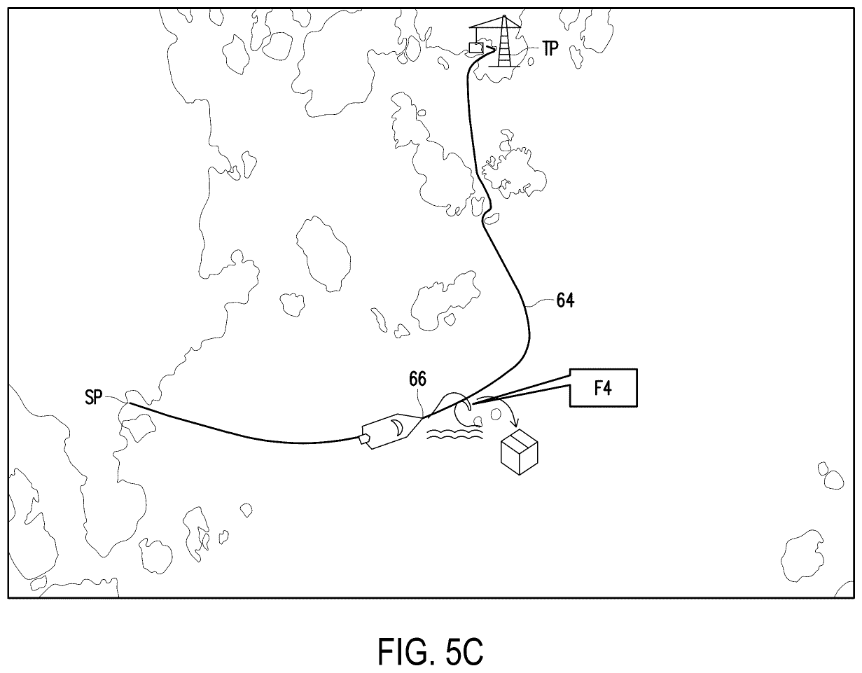

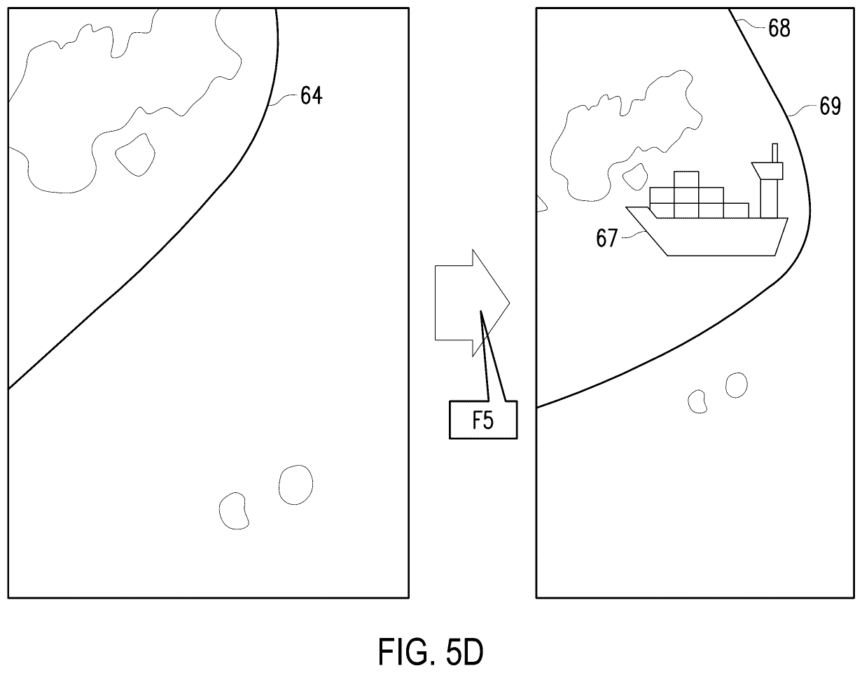

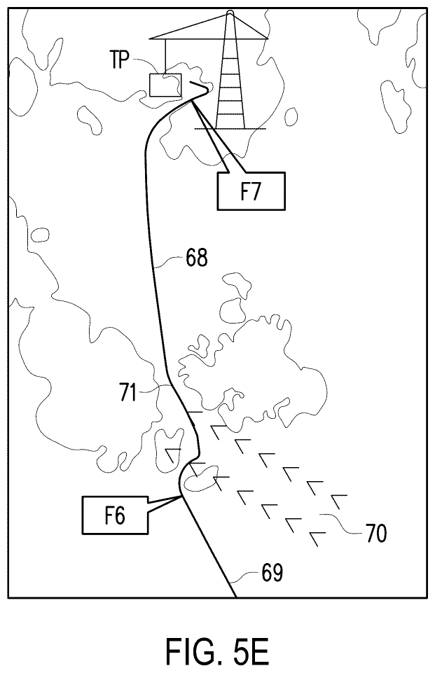

FIG. 4 provides an overview of an application scenario for the assistance system 1 for assisting a person in operating a marine vessel that operates in a plurality of functional modes and includes an automatic mode selection process according to an embodiment. FIGS. 5A to 5E subsequently display specific portions of the applications scenario of FIG. 4, discuss respective functional modes of the assistance system 1, and the provided functionalities of the disclosed assistance system 1 for the assisted person.

The assistance system 1 may operate in one or more functional modes out of a plurality of different functional modes available at a given point in time. The assistance system 1 may select the best functional mode automatically, based on available data and evaluating available data based on respective selection criteria. A user, in particular the assisted person may also manually select or change a functional mode for execution by the assistance system 1.

FIG. 4 illustrates a sequence of functional modes executed by the assistance system 1 while navigating along a route from a start point to a target destination in a coastal maritime environment that presents a series of challenges and hazards in operating the marine vessel.

The functional modes or functions of the specific embodiment of the assistance system 1 include the (F1) general alert mode, (F2) bad-weather-assistance mode, (F3) strong-current mode (disturbing-forces assistance mode F3), (F4) man-over-board mode or cargo-over-board mode, (F5) right-of-way assistance mode, (F6) navigation-channel-assistance mode, and (F7) docking-assistance mode.

FIG. 5A shows a view of the application scenario for the assistance system 1 that operates in the general alerting mode F1 and the bad-weather-assistance mode F2 along the section of the route of the marine vessel displayed in FIG. 4.

At the starting point SP for starting the voyage to the target point TP through the coastal maritime environments shown by the map of FIG. 5A, the captain of the marine vessel representing the assisted person that the assistance system 1 on board of the marine vessel is assisting in operating his marine vessel, is maintaining his cargo vessel in the harbor while he is waiting for a message where to deliver cargo at the destination harbor at point TP. On receiving the awaited message, a display of the cargo vessel shows the received message. The general alerting function of the assistance system 1 operating in the general alerting mode F1 informs the assisted captain that there is a new message on the screen of the display. The assisted captain may move to the screen and enter his destination harbor as a target TP for route navigation into the assistance system 1. Having input the target, the assisted captain starts the voyage, while the system might function in a generic navigation assistance mode not specifically illustrated in FIGS. 4 ad 5A. Operating in the navigation assistance mode, the assistance system 1 uses tactile stimulation 18 of the assisted captain to guide the assisted captain along a preferred route 62 by operating in the navigation assistance mode, for example through corrective stimuli from undesired directions in case of a route deviation. Arriving at waypoint 63, the assistance system 1 receives context information about a bad weather cell 61 on the preferred route 62 from the start point SP to the target point TP. Based on an evaluation of the obtained weather information, the assistance system 1 automatically selects the bad-weather-assistance mode F2. In the bad-weather assistance mode F2, the assistance system reassesses the best route from waypoint 63 to the target point TP and determines the new route 64 to represent the best route from the waypoint 63 to the target point RP. Using tactile stimulation via the tactile stimulation device 50, the assistance system 1 guides the assisted captain around the predicted path of the bad weather cell 62. After avoiding the bad weather, the system 1 automatically switches back to navigation mode.

FIG. 5B shows a view of the application scenario for the assistance system 1 that operates in the disturbing-forces assistance mode F3 according to an embodiment.

Arriving at waypoint 65 while the cargo vessel is navigating along the new route 64, the assistance system 1 receives information about a strong maritime current with a direction almost perpendicular to the intended course of the cargo vessel along the new route 64. in front of the cargo vessel. The assistance system automatically selects the disturbing-forces assistance mode F3. Before being effected by the maritime current, the assistance system 1 calculates the impact of the force on the cargo vessel and the intended trajectory of the cargo vessel along the new route 64. Based on the calculated impact of the recognized maritime current on the cargo vessel, the assistance system 1 guides the assisted captain is guided through the area of the maritime current stream by exerting a suitable tactile stimulation 18 to the assisted captain. On determining that the cargo vessel leaves the area of the strong maritime current 65, the assistance system 1 automatically terminates operating in the disturbing-forces assistance mode F3 and switches back to operating in the navigation mode.

FIG. 5C shows a view of the application scenario for the assistance system 1 that operates in a man-over-board mode F4 according to an embodiment.

While the cargo vessel navigates along the new route 64 from waypoint 65 onwards, the assistance system 1 detects that some of the cargo goes overboard at waypoint 66 due to high waves in addition to apparent cargo stowage problems. The assistance system 1 may recognize the problem based on camera images of the immediate environment of the cargo vessel or cameras monitoring the deck of the cargo vessel. Automatically, the assistance system 1 starts operating in the cargo-over-board mode F4. While operating in the cargo-over-board mode F4, the assistance system 1 provides to the assisted captain tactile stimulation 18 including tactile signals for communicating the direction towards the position where the cargo is swimming in the water. Hence, during maneuvering the cargo vessel into a position in which the cargo may be safely salvaged and taken on board again. After having the cargo taken on board of the cargo vessel again, the assistance system 1 automatically terminates operating in the cargo-over-board mode F4 and resumes operating in the navigation mode. It is to be noted that different information that is communicated to the assisted person might require different levels of attention, or that the assisted person needs to distinguish between different operation modes. An adapted communication using different modes is therefore preferred. This is achieved by different encoding schemes, especially for communication of information for which the desired reactions of the assisted person might conflict, like for example getting away from the communicated direction or moving closer to it. Dimensions for changing the encoding are e.g., actuation strength and frequency, as well as specific patterns containing variations of both. For example, low frequency pulses from a desired direction versus continuous stimulation from an undesired direction that becomes weaker as the course is corrected. Another option could be to provide a moving pattern that shows the “angular error” such that actuators along a range corresponding to a mismatch from a desired heading are activated in succession repeatedly, thus creating an illusion of movement along this angle. The use of such different modes allows the assisted person to distinguish between, for example, information related to the course of the vessel and crew or cargo overboard.

FIG. 5D shows a view of the application scenario for the assistance system 1 that operates in the right-of-way assistance mode F5 according to an embodiment.

While the cargo vessel continues navigating along the new route 64 from waypoint 66 onwards, the assistance system 1 detects a large vessel 67 whose predicted path intersects with the own planned path along the new route 64. The assistance system automatically starts operating in the right-of-way assistance mode F5. Operating in the right-of-way assistance mode F5, the assistance system 1 determines the other vessel 67 to have the right-of-way. The assistance system 1 now adjusts a computed trajectory for the marine vessel that deviates from the route 64 in order to account for the other vessel's right of way. The adjusted trajectory results in a corresponding shift in the momentary target direction depicted in the right portion of FIG. 5D and a new route 68 passing around the other vessel 67 at a larger distance to the coast of the island in the upper left portion of the map underlying FIG. 5D. After passing the other vessel 67, the assistance system 1 terminates operating in the right-of-way assistance mode F5 and proceeds with operating in the navigation mode based on an updated location 69 on the new route 68 towards the destination 62.

FIG. 5E shows a view of the application scenario for the assistance system 1 that operates in the navigation-channel guidance mode F6 and the docking assistance mode F7 according to an embodiment.

The cargo vessel continues navigating along the new route 68 from waypoint 69 onwards, the assistance system 1 approaches a section of the route 68, which leads through a narrow navigation channel 71 winding between multiple small islands. The navigation channel 71 to be followed by the cargo vessel is not straight and therefore requires multiple corrections of the course of the cargo vessel necessary while proceeding along the route 68 towards the target point TP. Approaching the navigation channel 71, the assistance system 1 starts operating in the navigation-channel guidance mode F6. The assistance system 1 provides guidance to the assisted captain of the cargo vessel via outputting tactile stimulation 18 by the tactile interface device 50 to support the captain in staying within a safe region within the navigation channel 71.

The navigation of the cargo vessel in the navigation channel 71 is additionally complicated by marine currents 70. The marine currents 70 may be weaker than the marine currents 65 previously encountered by the cargo vessel on the open sea. However, the reduced velocity of the cargo vessel while navigating through the narrow and winding navigation channel 71 in combination with the confined space for maneuvering the cargo vessel within the navigation channel 71, the effect on the course of the cargo vessel becomes significant.

In this scenario, the navigation-channel-guidance mode F6 and the disturbing-forces assistance mode F3 are preferably active functional modes of the assistance system 1 simultaneously.

The tactile interface device 50 may superimpose a current representation pattern of the output tactile stimulation 18 onto a component of the tactile stimulation 18 intended to avoid the cargo vessel approaching or even violating the channel boundaries of the navigation channel 71. The assistance system 1 thereby notifies the assisted person of the additional factor resulting from the marine currents 70 that may impair safe maneuvering within the narrow and winding navigation channel 71. The assisted captain may accordingly take more informed decisions on the course of the cargo vessel along the route 68 and may adjust the course of the cargo vessel accordingly.

After reaching the destination harbor at target point TP, the cargo vessel has to maneuver into an assigned docking position for unloading the cargo in the confined and possibly crowded area of the harbor. On entering the harbor, the assistance system 1 may automatically start operating in the docking assistance mode F7.

Alternatively, the assisted captain or a navigator switches the assistance system 1 from operating in the navigation into operating in the docking assistance mode F. When operating in the docking assistance mode, the assistance system 1 controls the tactile interface device 50 to output tactile stimulation 18 to the assisted captain of the cargo vessel that indicates directions and distances to elements (entities) of the dock to support the captain in understanding possible misalignments of the cargo vessels position with respect to the target position in the dock or along a pier of the harbor. The assistance system 1 may also support the captain approaching the dock in finding an ideal approaching angle. By using the information about the vessels target position and the vessels digital model, the system can automatically compensate internal forces. That includes, e.g., compensating the vessels wheel effect when slowing down by automatic actuation of a side thruster.

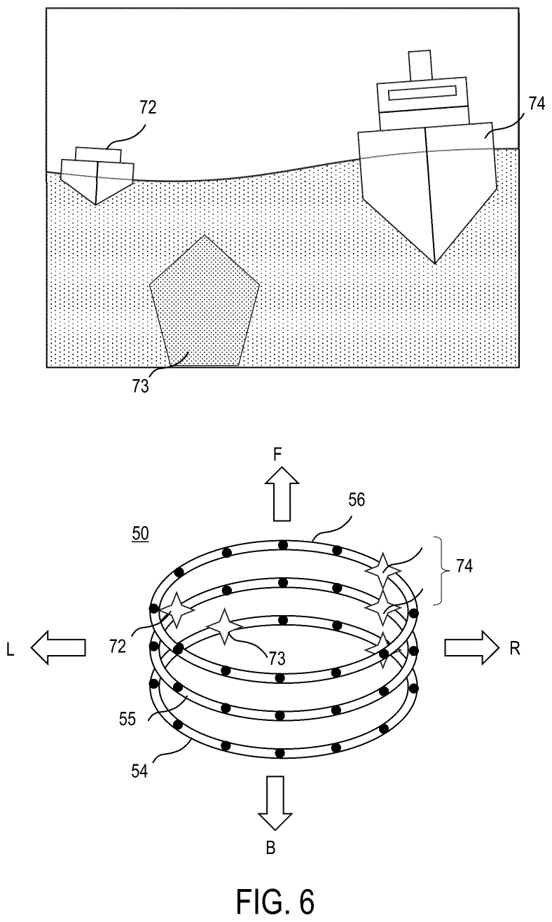

FIG. 6 shows a view of an application scenario for the assistance system 1 that has an extended tactile signaling capability and a respective actuator arrangement according to an embodiment.

In the basic form of the tactile interface device 50, the tactile actuators 17 arranged in wearable device such as a safety vest encircle the torso of the assisted person. The tactile interface device 50 may arrange gaps between individual actuators 17 that have a regular distance in some embodiments. Alternatively, the individual actuators 17 may be distributed around the body of the assisted person according to differences in local tactile sensitivity of the human body or resolution requirements of the specific application.

Some embodiments of the tactile interface device 50 embed the tactile actuators 17 also extending vertically, an arrangement of actuators 17, which may define a grid of actuators instead of an array. The grid of actuators 17 extending also in a vertical direction has the effect of expanding the possibilities for encoding of information, in particular of information with spatial components extending into three dimensions.

For example, while a circular array extending into two dimensions on a plane 54, 55, 56 may be used to point to a direction on a central horizontal plain, a grid extending into three dimensions (3D) may be used to expand pointing to other plains and even intermediate 3D directions by interpolation. For the marine applications of the maritime tactile communication by the assistance system 1, the lowest of e.g., three planes in a tactile grid can indicate sub-surface directions extending below the sea surface, the middle row on-surface directions on the surface of the sea, and the upper row above-surface directions as indicated in FIG. 6. The upper part of FIG. 6 shows a small ship 72 to the left forward direction of the assisted person, a large ship 74 to the right forward direction of the assisted person, both ships 72, 74 swimming on the sea surface. An obstacle 73 looms below the sea surface in a front left direction from the assisted person. The tactile actuators 17 of the tactile interface device in the lower part of FIG. 6 displays a respective encoding of the information representing the scenario in the upper part of FIG. 6. The small ship 72 to the left front of the assisted person is represented by the respectively labeled activated tactile actuator 72 on the center plane 55. The large ship 74 to the right front of the assisted person is represented by the respectively labeled activated tactile actuators 74 on the center plane 55 and the upper plane 56. The active actuator 73 in the left front on the lower plane 54 represents the obstacle 73 situated below the sea surface in a front left direction from the assisted person.

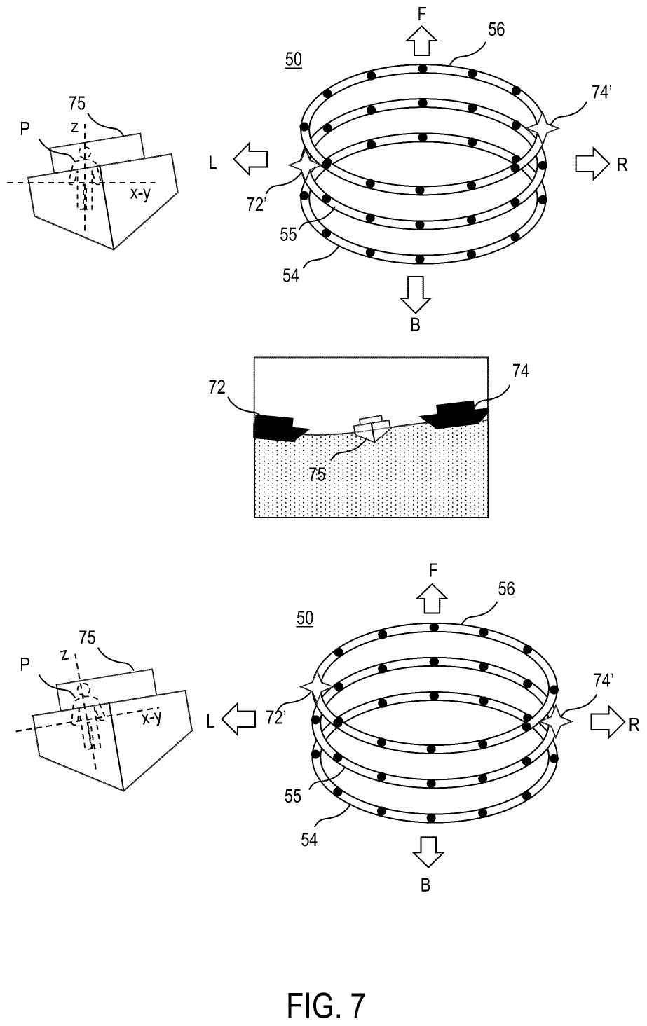

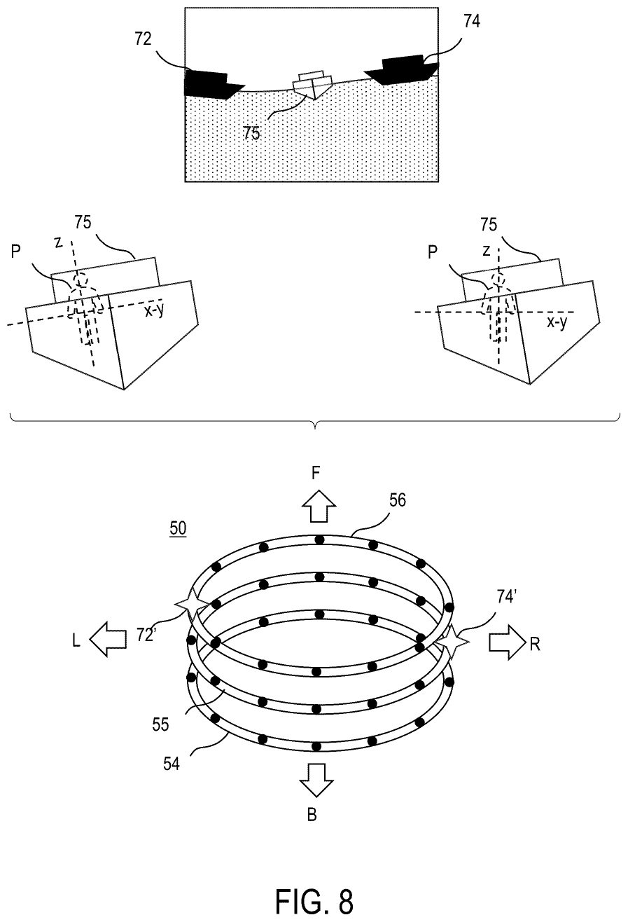

In an alternative embodiment, the multiple planes 54, 55, 56 each arranging circular rows of actuators 17 may be controlled in order to compensate for vessel movement on the water and respective movement of the assisted person with tactile interface device 50. The compensation of pitch, yaw, and roll movements enables to indicate directions correctly despite changes in roll angles, pitch angles, and yaw angles of the marine vessel or the assisted persons as indicated in FIGS. 7 and 8.

Additionally, a representation of external elements can be improved through an increased spatial resolution of the tactile interface device 50 with its vertical extension. In an example, wave movement directions in combination with wave heights may be conveyed simultaneously to the assisted person. By matching the timing of represented waves to the timing of the actual wave, the assisted person on board of the marine vessel can further be supported in accelerating and steering suitably to achieve a reduced wave impact on the marine vessel, the cargo and passengers on board of the marine vessel.

FIG. 7 shows a view of an application scenario for the assistance system 1 that has the extended tactile signaling capability and further provides roll angle, yaw angle, and pitch angle compensation.

The center portion of FIG. 7 shows a scenario of the marine vessel 75 with the assisted person P on board rolling in the sea due to waves. Two other ships 72, 74 are approaching the marine vessel 75 from the right and the left side respectively.

In the upper part of FIG. 7, the assisted person P wearing the tactile interface device 50 compensates by an own movement the rotation of his marine vessel 75. An x-y plane of the assisted person P does not follow the inclination of the marine vessel 75 due to the waves. The tactile interface device 50 has three planes 54, 55, 56 with circular strings of actuators 17 and exerts a tactile stimulation 18 to the body of the assisted person P that is spatially compensated for the movement of the marine vessel 75. The tactile representation 74′ by the active actuator 17 of the other ship 74 is therefore in the upper plane 56 of the arrangement of actuators 17 of the tactile actuator device 50, and on the right side of the body of the assisted person P. The tactile representation 72′ by the active actuator 17 of the other ship 72 is therefore in the lower plane 54 of the arrangement of actuators 17 of the tactile actuator device 50, and on the left side of the body of the assisted person P.

In the lower part of FIG. 7, the assisted person P wearing the tactile interface device 50, follows the rotation of his marine vessel 75 due to the waves. An x-y plane of the assisted person P follows the inclination of the marine vessel 75 due to the waves. The tactile interface device 50 with its three planes 54, 55, 56 with each plane having the circular string of actuators 17 exerts a tactile stimulation 18 to the body of the assisted person P that does spatially compensate for the movement of the marine vessel 75. The tactile representation 74′ by the active actuator 17 of the other ship 74 is therefore in the mid plane 55 of the arrangement of actuators 17 of the tactile actuator device 50, and on the right side of the body of the assisted person P. The tactile representation 72′ by the active actuator 17 of the other ship 72 is therefore in the upper plane 55 of the arrangement of actuators 17 of the tactile actuator device 50, and on the left side of the body of the assisted person P.

In either the upper case of the assisted person P compensating a rotation of the marine vessel 75 or in the lower case of the assisted person P not compensating the rotation of the marine vessel 75 due to the waves, the assistance system 1 indicates the tactile representations 72′, 74′ at the correct relative positions in the coordinate system of the assisted person P. The tactile interface device 50 provides a representation of the relevant elements in the maritime scenario in the environment via the actuator grid with three strings of actuators 17 relative to the orientation of the assisted person P.

FIG. 8 shows a view of the application scenario for the assistance system 1 that has the tactile signaling capability into three dimensions and further provides roll angle, yaw angle, and pitch angle compensation in a further embodiment.

The upper portion of FIG. 8 shows the scenario of the marine vessel 75 with the assisted person P on board rolling in the sea due to waves. Two other ships 72, 74 are approaching the marine vessel 75 from the right and the left side respectively. The scenario in the maritime environment of FIG. 8 corresponds in all aspects to the scenario depicted in FIG. 7. As in FIG. 7, the assisted person P may either compensate the movement of the marine vessel 75 or not compensate the movement of the marine vessel 75 due to the waves.

In the center left part of FIG. 8, the assisted person P wearing the tactile interface device 50 compensates by an own movement the rotation of his marine vessel 75. An x-y plane of the assisted person P follows the inclination of the marine vessel 75 due to the waves and has a varying inclination angle with the coordinate system. In the center right part of FIG. 8, the assisted person P wearing the tactile interface device 50 does compensate the rotation of his marine vessel 75 due to the waves by an own movement and maintains an upward posture in the global coordinate system by an own movement relative to the marine vessel 75. An x-y plane of the assisted person P in the case of the right center part of FIG. 8 does therefore not follow the inclination of the marine vessel 75 due to the waves and has no varying inclination angle with the global coordinate system.

In the embodiment of FIG. 8, as illustrated in the lower part of FIG. 8, the tactile interface device 50 has three planes 54, 55, 56 with circular strings of actuators 17 and exerts a tactile stimulation 18 to the body of the assisted person P that is spatially compensated for the movement of the marine vessel 75. The tactile representation 74′ by the active actuator 17 of the other ship 74 is in the center plane 55 of the arrangement of actuators 17 of the tactile actuator device 50, and on the right side of the body of the assisted person P. The tactile representation 72′ by the active actuator 17 of the other ship 72 is therefore in the upper plane 56 of the arrangement of actuators 17 of the tactile actuator device 50, and on the left side of the body of the assisted person P. The alternate option of FIG. 8 encodes both scenarios, which are the same as show in FIG. 7 using the same encoding scheme. This provides for a steady tactile stimulation 18 of the assisted person P. The encoding scheme shown in FIG. 8 shows no spatial variations in the tactile stimulation 18 of the body of the assisted person in response to an inclination movement of the assisted person relative to the marine vessel, contrary to the embodiment of FIG. 7.

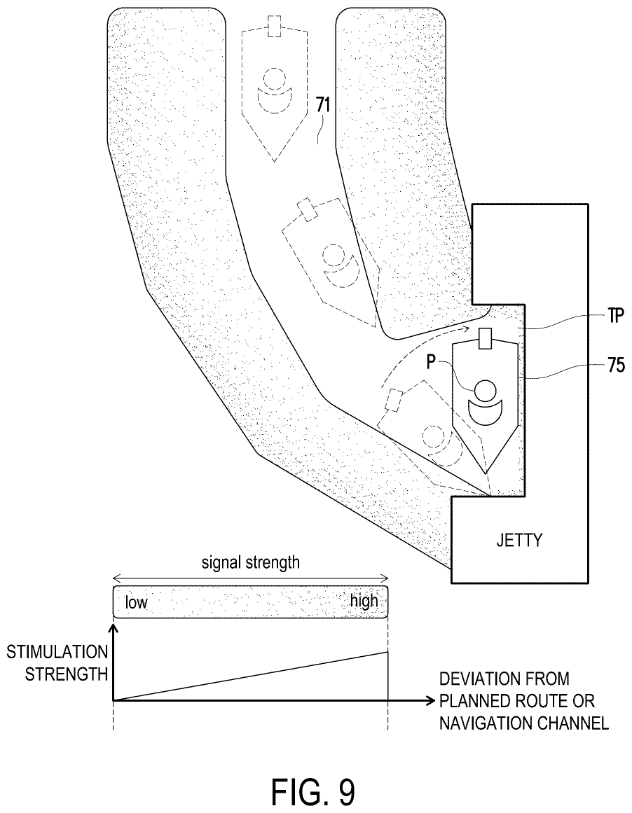

FIG. 9 shows a birds-eye view of an application scenario for the assistance system 1 that operates in the navigation-channel guidance mode F6 or the docking assistance mode F7 according to an embodiment.

In the navigation-channel guidance mode F6 and the docking assistance mode F7, the assistance system 1 uses information on the environment of the marine vessel 75 acquired by systems that may include positioning systems including, e.g., a satnav system, GPS and sensors based on LIDAR, RADAR, cameras or contact sensors, in combination with corresponding software for evaluating the positioning signals and the sensor signals. The assistance system 1 may further use context information, e.g. publicly available navigation charts and map data on harbor facilities. The tactile interface device 50 controlled by the assistance system 1 guides the assisted person P and the marine vessel 75 operated by the assisted person P along a planned navigation channel 71 (corridor) for a safe or optimal passage towards a target point TP. In case of the assisted person P and the marine vessel 75 deviating from the planned navigation channel, the assistance system 1 controls the tactile interface device 50 to provide a stimulation of a respective stimulation strength to the assisted person P. FIG. 9 illustrates the respective strength of the encoded deviation from the planned navigation route in the navigation channel 71 by the stimulation signal. The larger the deviation of the assisted person P from the navigation channel is, the higher is the strength of the tactile stimulation 18. FIG. 9 illustrates the stimulation strength of the tactile stimulation in dependence on a deviation from the navigation channel 71 or planned route of the marine vessel 75 towards the target point TP by a respective shading of the position in the depicted map. In the exemplary encoding of FIG. 9, as long as the assisted person P moves with the marine vessel 75 within the navigation channel 71, the assistance system 1 controls the tactile interface device 50 to output no tactile stimulation 18 to the assisted person P.

In the docking mode, based on a digital model of the vessel, the system can suggest throttle position and rudder angle to maneuver the vessel to the desired spot. The digital model comprises information on power, size, wind effective area, moment of inertia along linear and rotational axis and rudder position. Further information on physical characteristics and reactions of the vessel on external forces can be included in the model, if available. Based on the model, the system can calculate a throttle position and rudder angle necessary to maneuver the vessel to the desired spot. It is specifically preferred to consider knowledge about wind and current in the calculation. The assistance to the assisted person is then executed using the tactile interface 50, based on the calculated throttle position and rudder angle. For example, the deviation of the calculated rudder position is communicated via the angle where the signal is generated in the tactile interface device. A small deviation of the actual rudder angle from the calculated steering angel to the left could result in a signal provided at a small angle, for example 10° to the right (relative to the assisted person's center), indicating that the rudder position should be corrected to the right. Accordingly, a larger deviation would result in a larger angle, e.g., 70°.

In order to communicate a correction of the actual throttle position, a vibration frequency can encode the deviation of the actual throttle position from the calculated target throttle position. For example, the vibration frequency could be proportional to the deviation. In case the assisted person should correct the throttle position to cause a moderate acceleration, the stimulation could be made using a low frequency signal at the assisted person's front side. Vice versa, the stimulation could use a high frequency signal on the assisted person's back side to cause a correction for quickly slowing down.

It is to be noted that both patterns can be outputted simultaneously to constantly update the assisted person about his deviation to the calculated rudder and throttle position.

Preferably, the output strength of the stimulation can be adapted to the reaction of the user as a form of (optionally continuous) individual user calibration. For example, when a user reacts to a 30° rotation by applying 25° counterrotation, the system can recognize this relation between the communicated correction and the actually performed correction of the rudder position. So if the correction made by the assisted person stays behind the intended correction, the range of communicated angle may be increased. According to another example, the user reacts to front risk only once the expression level of a stimulus or stimulus-component reaches 10%. The system can identify this correlation and increases the baseline level to 10%.

The strength of the tactile stimulation may correspond to a vibration frequency or a vibration amplitude or the magnitude of an applied pressure of the tactile stimulation output by the tactile actuator 17.

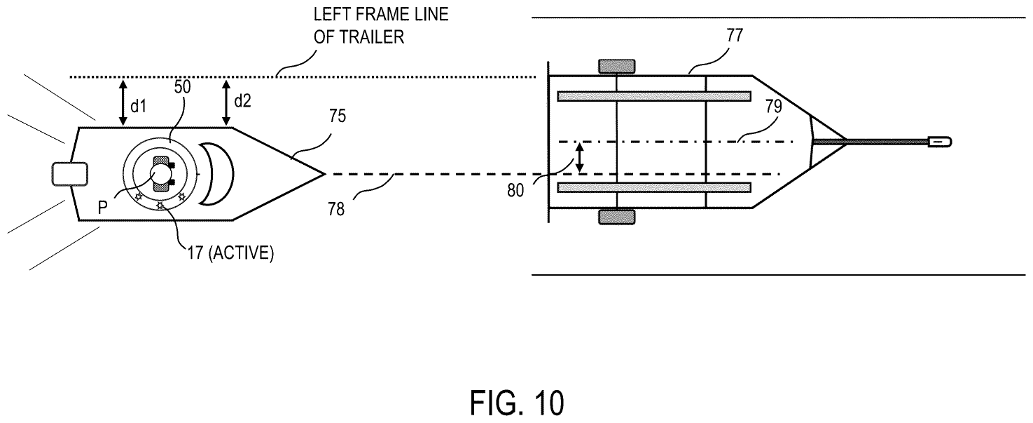

FIG. 10 shows a birds-eye view of a specific application scenario for the assistance system 1 that that covers a trailer-loading process for the maritime vessel 75.

In the scenario of FIG. 10, the assistance system 1 supports the assisted person wearing the tactile interface device 50 when performing the task of loading the marine vessel on a trailer 77. The assistance system 1 provides assistance in order to align a centerline 78 of the marine vessel 75 and a centerline 79 of the trailer 77 when navigating the marine vessel towards the trailer 77 that is located on a ramp running into the water. The centerlines 78, 79 of the marine vessel 75 and the trailer 77 are in parallel when the maneuver is successfully finished.

The target of the assistance by the assistance system 1 is that an offset 80 between the centerlines 78, 79 becomes zero or lies within a specific tolerance. Simultaneously, the condition that the sidewall of the marine vessel 75 aligns as intended with the frame line(s) of the trailer 77. In FIG. 10, these conditions are met when the distances di and d2 become equal to a predetermined target value. Given this case, the assisted person is able to navigate the marine vessel 75 onto the trailer 77. In an exemplary embodiment, the assistance system 1 provides a tactile stimulation to the assisted person P, that encodes the offset in a strength and a direction of the tactile stimulation 18 provided to the assisted person P. The active actuators 17 shown in the example of FIG. 10 will act to push the assisted person P to move the marine vessel 75 towards the left frame line of the trailer 77 and thereby reducing the offset 80. Thus, the tactile stimulation 18 indicates how the assisted person P has to act in the current situation in order to achieve their target.

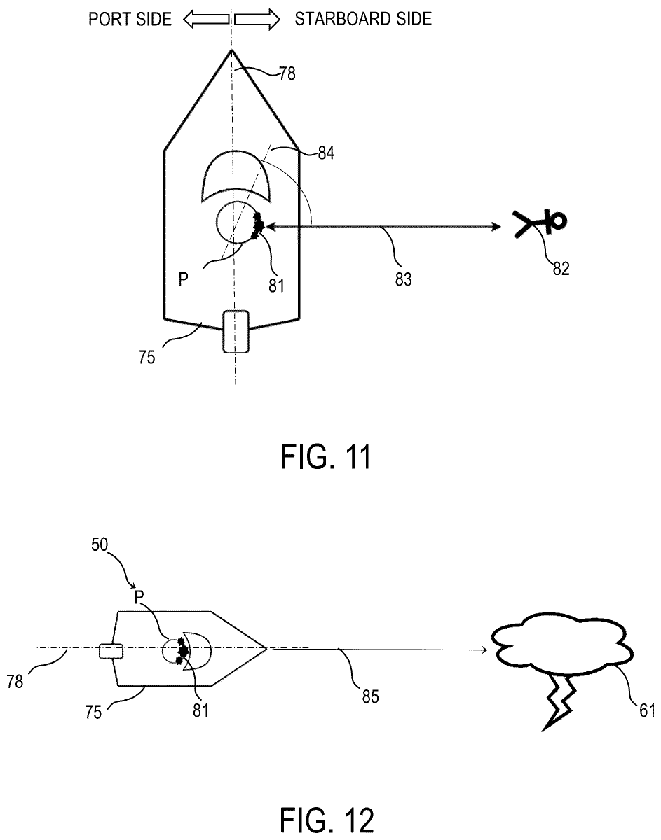

FIG. 11 shows a birds-eye view of an application scenario for the assistance system 1 that provides support to an assisted person P in a man-over-board scenario for the maritime vessel 75. The depicted scenario corresponds to the scenario of the assistance system 1 operating in the cargo-over-board mode F4 discussed with reference to FIG. 5C.

In FIG. 11, a person 82 went over board of the marine vessel 75 that the assisted person P wearing the tactile interface device 50 of the assistance system 1 operates. In the depicted scenario, the person 82 is on the starboard side of the marine vessel 75.

A camera sensor arranged in an elevated position on the marine vessel 75 obtains environment information that enables to locate the person 82 in the water and determine a position and a direction towards the person relative to the orientation of the marine vessel 75 as indicated by the centerline 78 of the marine vessel 75. The assistance system 1 computes second spatial information including the position and direction of the person 82 relative to the position and orientation 84 of the tactile interface device 50 worn by the assisted person P. The assistance system 1 controls the tactile interface device 50 to output a tactile stimulation 18 to the assisted person P that includes, e.g., a vibration signal 81 that points towards the person 82 in the water as indicated by the active tactile actuators 17 represented by stars in FIG. 11. Operating in the man-over-board mode F4, the assisted person P knows where to direct the marine vessel 75 without distraction of his visual and auditory senses.

Alternatively, the assisted person P may be deckhand on board of the marine vessel 75, who moves around the marine vessel 75 for fetching a lifebuoy or lifeline and to throw the lifebuoy towards the person 82 in the water. While the helmsman is moving the marine vessel towards the person 82, the deckhand continuously receives a tactile stimulation 18 informing him or her on the current direction towards the person 82 in the water, while he focuses his visual senses to finding a storage position of the lifebuoy, moving to the storage position, grasping the lifebuoy, moving with lifebuoy to a suitable position for throwing it towards the person in the water.

The assistance system 1 operating in the man-over-board mode or the cargo-over-board mode F4 may, for example, encode a direction towards the person 82 relative to the assisted person P wearing the tactile interface device 50, thereby the encoded information accounts for an ego rotation of the assisted person P. Additionally, in the man-over-board mode or the cargo-over-board mode F4 of the assistance system 1, a strength of the tactile stimulation 18, for example a value of a stimulation frequency or stimulation amplitude or stimulation force, may encode the distance from the assisted person P to the person 82 in the water.

FIG. 12 shows a birds-eye view of an application scenario for the assistance system 1 that that operates in the bad-weather-assistance mode F2 in an application scenario for the maritime vessel 75.

The scenario of FIG. 12 determines bad weather conditions that are detected close to the marine vessel 75 directly ahead in a moving direction 85 of the marine vessel 75.

The bad weather illustrated by a static bad weather cell 61 in FIG. 12 may not necessarily describe a current event but can also refer to a probable and sufficiently severe future development in the environment of the marine vessel 75. The assistance system 1 may obtain information on the bad weather event from a public weather forecast included in the information on the environment or may alternatively receive current weather information from other vessels. The tactile interface device 50 may communicate a bad weather vector 85 via a tactile stimulation 18 to the assisted person P based on the control signal generated by the assistance system 1. The communicated bad weather vector 85 may indicate that the assisted person P may expect bad weather approaching from a direction indicated by the bad weather vector 85 in the future, if the current course of the marine vessel 75 is maintained.

In an embodiment of the assistance system 1 operating in the bad weather assistance mode F2, a difference between weather conditions currently perceivable at the location of the assisted person P and information communicated by the tactile stimulation 18 in the bad-weather-assistance mode F2 may exist. This applies because a perceivable information relates to the immediate past state at the currently observed location and not necessarily indicates a future state at the same location.

FIG. 12 displays an example encoding for the predicted bad weather, in which the direction of the bad weather cell 61 is encoded in the direction relative to the assisted person P wearing the tactile interface device 50. Additionally, a strength of the tactile stimulation 18, for example, a value of a stimulation frequency or of a stimulation amplitude, may encode the distance from the assisted person P to the bad weather cell 61.

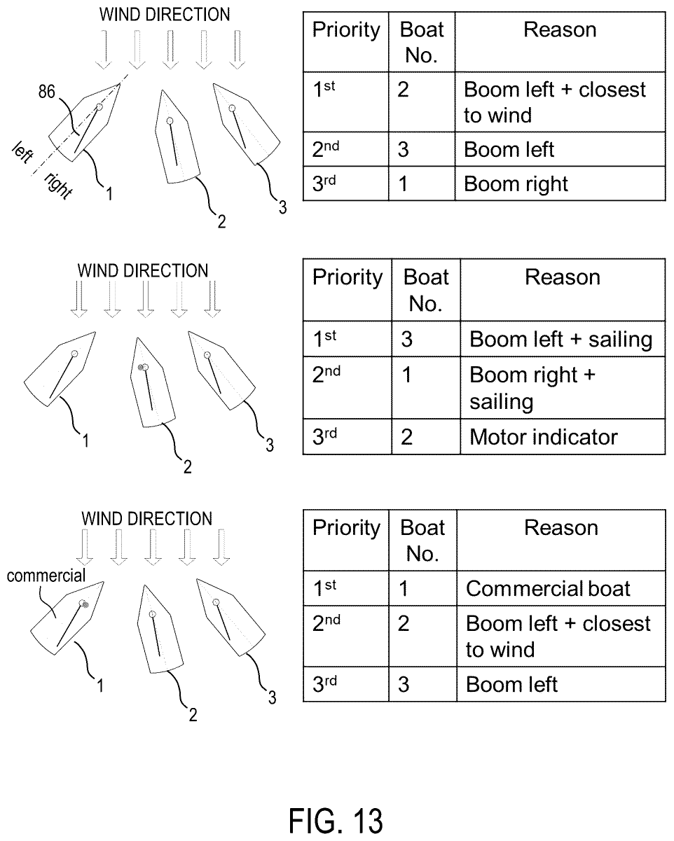

FIG. 13 illustrates aspects of the assistance system 1 operating in the right-of-way assistance mode F5.

There are many factors that determine the right of way for marine vessels, including, e.g., a type of vessel, the course of the vessel, the wind direction, the purpose of sailing. The type of vessel may include a passenger vessel in line duty that has preference over a boat on a leisure cruise. A sailing yacht may have precedence over a motor boat. A sailing yacht participating in a competition may have precedence over a sailing yacht on a leisure trip. The rules or customs may vary in different areas, although the key rules are the same. The tables of FIG. 13 illustrate aspects of determining the right of way for sailing yachts depending on wind direction, course of a sailing yacht with regard to the course of the other sailing yacht in relation to the wind direction, and the current position of the boom 86 of the main sail.

The assistance system 1 may, based on the acquired information on the environment from, e.g., radar and AIS information receivers, control the tactile interface device 50 to indicate to the assisted person P the current right of way situation in an observed scenario. The assistance system 1 may generate the right-of-way information by evaluating the monitored scenario in the environment involving a plurality of marine vessels by referring to stored tables with right-of-way information, similar to the tables shown in FIG. 13, and pre-stored rules. This may give the assisted person P support in resolving a complex right-of-way scenario, improve confidence of the assisted person P and reduces stress levels for the assisted person P in addition to improve safety in right-of-way situations in the maritime environment.

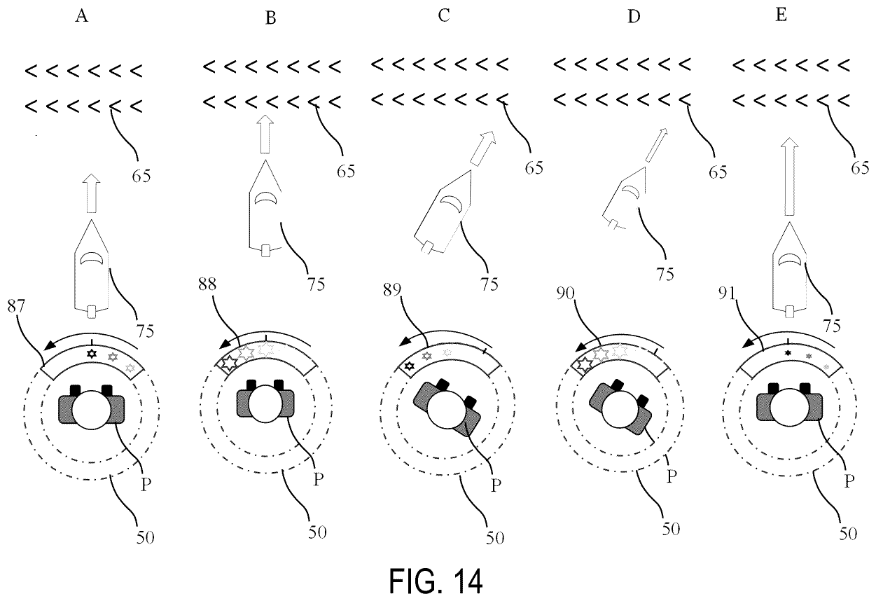

FIG. 14 shows example scenarios of the assistance system 1 operating in the disturbing-forces-assistance mode F3, illustrating respective exemplary encodings for the tactile stimulation 18 output by the tactile interface device 50.

Instead of implementing push-analogies or pull analogies for desired movement vectors for the marine vessel 75, the tactile stimulation may also directly encode environmental elements such as external forces that act or are predicted to act on the marine vessel 75 if it maintains its current course in the environment. Alternatively, or additionally, a predicted impact of environmental elements such as external forces that act or are predicted to act on the marine vessel 75 if it maintains its current course in the environment may be encoded in the tactile stimulation 18.

FIG. 14 displays five exemplary scenarios A, B, C, D, and E, each scenario resulting in a specific encoding of the secondary spatial information of that scenario in a particular tactile stimulation 18 for that scenario. The assisted person P wears a tactile interface device 50 with a circular string of actuators 17 arranged around the body of the assisted person P.

In FIG. 14, for circular string of actuators 17 of the tactile interface device 50, active actuators 17 are indicated by stars (tactile stimulation actuator 17), the size of a star indicates the actuation strength (for example, pressure level, vibration amplitude or vibration frequency), and the opacity of the star indicates the time that has elapsed since the respective tactile corresponding actuator 17 had been active. Thus, the second spatial information is not only encoded in a actuation strength and a position of a vibration actuation relative to the assisted person P, but also in a sequence of actuator engagement (active actuators 17).

In FIG. 14, an arrow indicates a direction of movement of the marine vessel 75, a length of the arrow corresponds to the velocity of the marine vessel 75, and a width of the arrow corresponds to the mass of the marine vessel 75.

In scenario A, the marine vessel 75 is moving towards a marine current 65 that moves orthogonal to the intended route of the marine vessel 75.

The tactile stimulation 18 output by the tactile interface device 50 includes tactile stimuli of the tactile representation 87 visualized by stars on circle: the movement direction of the marine current 65 is encoded in a movement pattern on the side of the tactile interface device 50 that faces the marine current 65. The movement pattern may, e.g., comprise actuators 17 that activate and deactivate in close succession to create a perception of apparent motion from one side of the tactile interface device 50 to the other side of the tactile interface device 50, from the right side to the left side in FIG. 14.

In scenario B, the marine vessel 75 is again moving towards the marine current 65 that moves orthogonally to the intended route of the marine vessel 75.

As the marine current 65 is significantly closer than in scenario A, the strength of the active actuators 17 increases in the tactile representation 88 of scenario B, communicating an increased probability or effect of the impact that the marine current 65 is predicted to have on the planned trajectory of the maritime vessel 75 in the near future.

In scenario C, the marine vessel 75 is again moving towards the marine current 65, however, the assisted person P did react by amending the course of the marine vessel 75 towards the perceived location of origin of the marine current 65 that moves orthogonal to the originally intended route of the marine vessel 75.

For compensating for the effect of the marine current 65 on the intended trajectory, the course of the marine vessel 75 had been changed. Thus, the predicted impact on the intended trajectory of the marine vessel 75 is reduced compared to scenario B. A rotation of the assisted person P, e.g., the navigator or helmsman of the marine vessel 75, relative to the marine current 65 shifted the subset of actuators 17 that are active actuators 17 of the set of actuators 17 in the circular arrangement of the tactile interface device 50. The subset of active actuators 17 included in the tactile pattern generation of the tactile representation 89 ensures maintaining alignment of the active actuators 17 of the subset with the current direction of the marine current 65 relative to the assisted person P.

In scenario D, the marine vessel 75 is again moving towards the marine current 65 and the assisted person P reacted by amending the course of the marine vessel 75 towards the perceived location of origin of the marine current 65 that moves orthogonal to the originally intended route of the marine vessel 75.

However, in the scenario D, the marine vessel 75 is assumed to be a smaller and lighter ship, having a lower momentum, and therefore the impact of the marine current is predicted to be larger than for a larger ship as assumed in scenario C of FIG. 14.

Thus, the predicted impact on the intended trajectory of the marine vessel 75 is increased compared to scenario C. The rotation of the assisted person P relative to the marine current 65 shifted the subset of actuators 17 that are active actuators 17 of the set of actuators 17 in the circular arrangement. The subset of active actuators 17 used for communication is selected to ensure maintaining alignment of the active actuators 17 of the subset of actuators 17 used for the tactile representation 90 with the current direction of the marine current 65 relative to the assisted person P. However, in scenario D, an actuation strength of the active actuators 17 of the subset is increased when compared with the respective activation strength of the actuators 17 of the subset of active actuators 17 in scenario C in order to account for the predicted larger impact of the marine current 65 in scenario D.

In scenario E, the marine vessel 75 is again moving towards the marine current 65 that moves orthogonal to the intended route of the marine vessel 75. The marine vessel 75 of scenario E has a higher momentum than the marine vessel 75 of scenario A and B. The impact of the marine current 65 is predicted to be lower than for a ship with less momentum, e.g., the marine vessel of scenarios A and B. In consequence, the tactile stimulation representation 91 of scenario E includes a subset of active stimuli 17 with a weaker stimulation strength compared to the stimulation strength of the stimulation representation 87 of scenario A and the stimulation representation 88 of the scenario B.

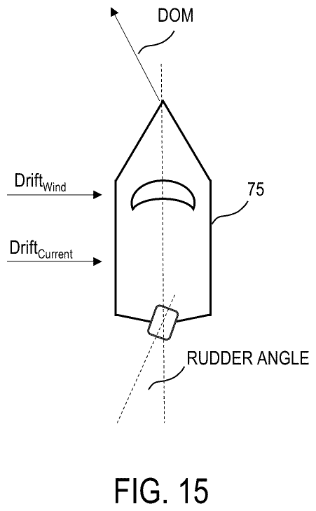

FIG. 15 shows a basic scenario for determining stimulus encodings in a maritime scenario for the assistance system 1 operating in the disturbing-forces assistance mode F3.

The direction of movement (DOM) of the marine vessel 75 is influenced by a rudder angle (steering angle), the drift caused by a marine current 65 and a drift caused by wind. The direction of movement DOM, e.g. by a compass or a positioning system such as a SATNAV system, the rudder angle using an angle sensor and the wind velocity as well as the wind direction by a wind sensor, the influence of the marine current is calculated as

DOM=drift_{wind}+drift_{Current}+rudder angle,
which provides for the marine current:

>drift_{Current}=DOM−drift_{Wind}−rudder angle;

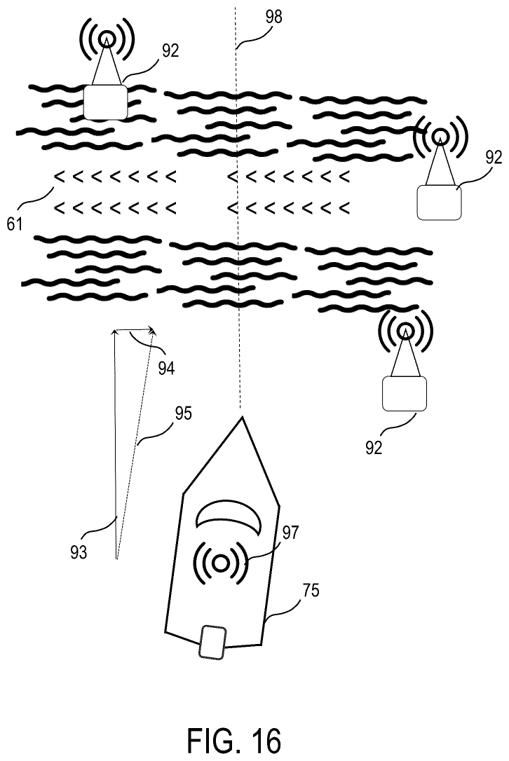

This indirect measurement of the current drift drift_{Current} is less recommendable for prediction purposes. FIG. 16 shows a specific scenario for determining stimulus encodings in a maritime scenario involving winds for the assistance system operating in the disturbing-forces-assistance mode F3 providing further implementation details using a direct measurement feasible for prediction purposes.

FIG. 16 illustrates an embodiment of the assistance system 1, which acquires sensor data on the environment from sensor measurement buoys 92. Each of the measurement buoys 92 anchored over an area of the sea where marine currents are occurring, e.g., due to submarine topography, winds or tidal effects, is equipped with a marine current sensor and a wireless network transceiver for connecting the measurement buoy 92 with other elements of a marine current measurement network. This measurement network includes a plurality of measurement buoys 92 and measurement processing capabilities for processing the acquired sensor data. The marine current measurement network generates information on the environment that includes information on the marine current 61, e.g. on a strength, on a direction, and on a geographical area where the marine current 61 is detected. The generated information on the marine current is distributed, e.g. via wireless communication network, to ships in or close to the area of the marine current 61 or may be accessed by ships intending to navigate in the region of the marine current measurement network. The marine vessel 75 with the assistance system 1 is equipped with a wireless transceiver 97 and is about to enter a region in which the marine current measurement network acquires sensor data on the marine currents 61 as an element of the information on the environment for processing in the assistance system 1.

Operating in the navigation assistance mode, the disturbing-forces-assistance mode F3 or the navigation-channel assistance mode F6, the marine vessel 75 intends to navigate the area of the marine current 61 on the intended route 98, having the intended direction of movement 93. The assistance system 1 computes, based on the obtained information on the environment, in FIG. 16 including information on the strength and direction of the marine current 61, a correction value 94 for compensating the drift due to the marine current 61 for the marine vessel 75 along its intended route passing through the area of the marine current 61. The assistance system 1 determines, based on the intended movement direction 93 and the computed correction data 94, a corrected movement direction 95. The corrected movement direction for the marine vessel 75 forms the basis for first spatial information and second spatial information, and the support to the assisted person P output via the tactile interface 50 of the assistance system 1.

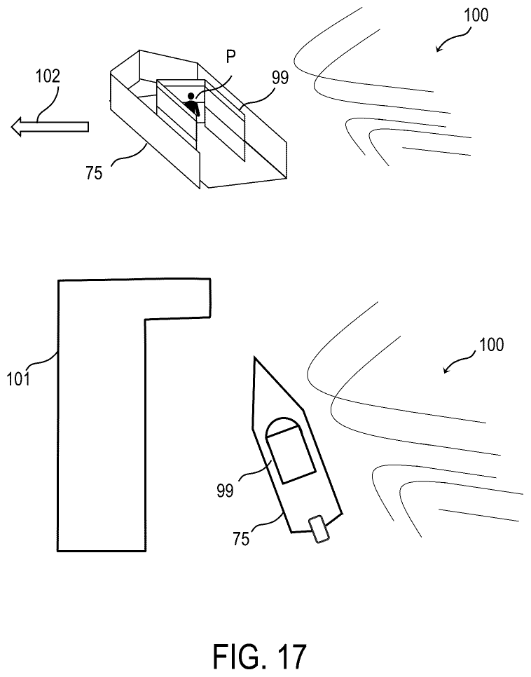

FIG. 17 shows a further advantageous scenario for illustrating advantageous effects of stimulus encodings in a maritime scenario involving wind for the assistance system 11.

The marine vessel 75 is operating under control by the assisted person P, which is within an at least partially closed deckhouse 99 of the marine vessel 75 and therefore shielded from external influences such wind 100 and wind gusts. The assisted person P may therefore have difficulties in grasping the effect of the wind 100 coming from the starboard side of the marine vessel and resulting in a drift 102 due to wind towards the port side of the marine vessel 75 as illustrated in the oblique view in the upper part of FIG. 17. This drift 102 may be increased due to the structure of the deckhouse 99 elevating significantly above the sea level than the hull of the marine vessel 75. The effect of the wind drift 102 may prove crucial in a situation, which in the direction of the marine vessel 75 opposite to the side of the marine vessel 75 facing the wind, a structure, e.g. a pier 101, a coastline, a shoal or a reef is situated. This scenario is depicted in the lower part of FIG. 17, where to the lee of the marine vessel 75, the pier 101 is shown.

The assistance system 1 may obtain in the information on the environment of the marine vessel 75 information on a strength and a direction of the current wind via a wind sensor. Additionally or alternatively, the information on the environment of the marine vessel 75 may include information on predicted gusts of wind, which may be generated by evaluating visual information on the wave structure towards the direction from which the wind is blowing. The assistance system 1 may generate the first and the second spatial information based on the evaluated current and predicted information on the wind, e.g. wind strength and wind direction, and encode the wind strength and wind direction into the tactile stimulation 18 of the assisted person P. Hence, the assisted person P, although being shielded from the elements including wind 100, obtains via the tactile device 50 stimulation relevant for operating the marine vessel 75. It is also possible to encode the impact the wind has on the vessel 75. For example, during docking the vessel 75 moves slowly and wind has a stronger effect on lateral movement.

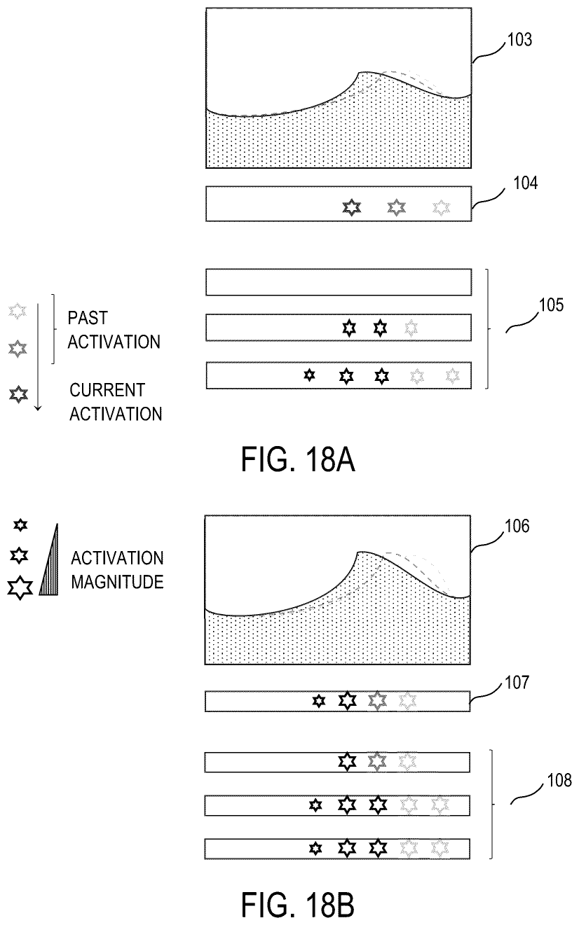

FIG. 18A and FIG. 18B illustrate a scenario illustrating stimulus encodings in a maritime scenario involving waves for the assistance system 1 showing useful implementation details. Generally, depending on the dimensionality and resolution of the tactile interface device 50, a tactile representation of environmental elements output in the tactile stimulation 18 may differ.

The size of the stars indicates a magnitude of a tactile actuation variable such as a actuation frequency or an amplitude of a tactile-signal-generating actuator 17. The opacity of the stars shows a current activation via full color and past activations in a slightly less dark tone to indicate a change of the activation of the actuator 17 over time.

FIG. 18A shows first instance of a wave 103 passing by in front of the marine vessel 75 and examples for a corresponding tactile representation for a tactile interface device 50 with one spatial dimension in the upper example for an encoding 104 and two spatial dimensions in the lower example for an encoding 105 of FIG. 18A.

The second instance of a wave 106 in FIG. 18B has a larger height of the wave than the first instance of a wave 103 in FIG. 18A. The proposed examples 104, 105, 107, and 108 for encoding the waves in the tactile stimulation 18 represent the different heights of waves and the steeper slopes in the tactile stimuli in perceivable manner for the assisted person P. The encoding may either be set to be an absolute representation of wave size or be relative to the predicted impact. This allows to represent the same wave smaller or larger depending on the size of the operated vessel, i.e., larger for a small vessel and smaller for a large vessel.

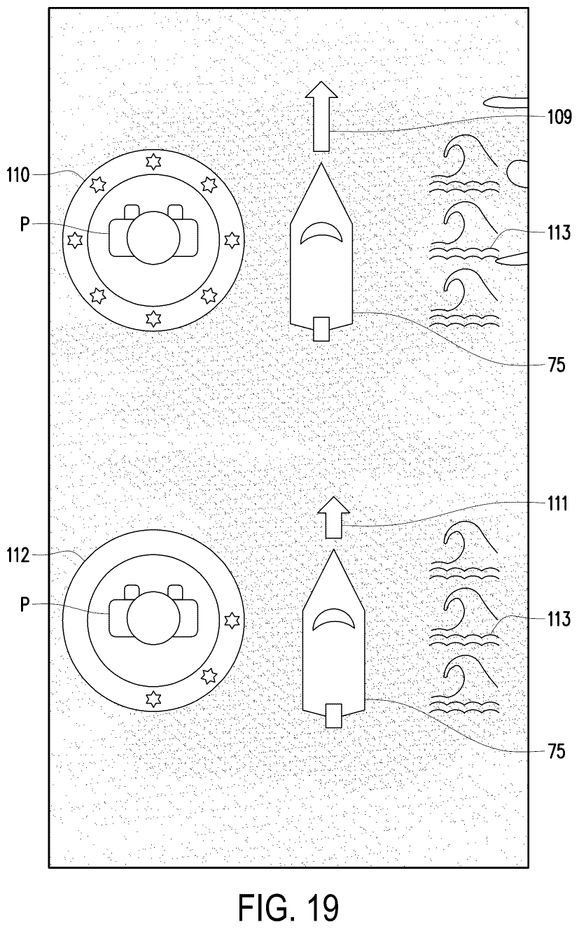

FIG. 19 illustrates a further scenario for determining stimulus encodings in a maritime scenario involving waves for the assistance system illustrating advantageous effects of the assistance system 1.

Encoding of elements in the environment, including, e.g., objects, events, and states that are predicted to impact the navigation of the marine vessel 75 and the safety of maritime traffic in the tactile stimulation of the assisted person P, results in selectively augmenting the perception of the encoded elements in the environment by the assisted person P. This concerns in particular those elements that the assisted person P presumably has not been perceived appropriately under the currently prevailing conditions. The assistance system 1 uses the tactile stimulation 18 of the assisted person P for communicating the cause of an issue in the environment that the assistance system 1 determines as relevant in performing the task at hand. The assistance system 1 evaluates how well the current and projected states of the marine vessel 75 comply with, e.g., safety goals and navigation targets. When the compliance is insufficient, the assistance system 1 draws the attention of the assisted person P to corresponding elements by the tactile representation output via the tactile stimulation 18 of the assisted person P.

It is to be noted that in general, there may be more than a single cause and information about at least one cause (or co-determinant) of the predicted unfavourable condition that have not been fully accounted for by the current or predicted state of the vessel or recognized actions of its operator. Actions that have been taken by the vessel operator may change what needs to be communicated. For example, an increase of the vessel's velocity reduces the effect of a current. Consequently, the communication strength of the current can be reduced, because the unfavourable condition (current) has been accounted for by the increased speed.

FIG. 19 provides an example for a predicted route deviation by a marine current 61 or wind. In the example, the tactile stimulation 18 extends beyond an encoding where an issue may occur, but also encodes in a suitable representation a cause of the detected issue by a specific actuator activation pattern that is output by the actuators 17 of the tactile interface device 50. The disclosed assistance system 1 may induce various actions by the assisted person P that may result in re-evaluating the situation in the environment to increase or decrease compliance with situation objectives and corresponding signaling in a further evolvement of the scenario. A representation of elements in the environment output via the tactile interface device 50 controlled by the assistance system 1 is therefore not to be confused with recommending specific actions, but increases situational awareness of the assisted person P.

Another example is an appearance of weather conditions that limit visibility. Low visibility scenarios as indicated in FIG. 19 might be evaluated by the assistance system 1 to stand in conflict with a high cruising velocity 109. However, such visibility events are not necessarily direction-specific, as the low visibility applies in all directions relative to the assisted person P and the marine vessel 75. Hence, the encoding in the tactile stimulation 18 might be independent of the direction (direction unspecific encoding), as indicated by the upper part of FIG. 19 in a first encoding example under low-visibility conditions. The tactile stimulation 18 may include in the representation 110, e.g., small or slow vibrations (pulsation) in all directions of the tactile interface device 50. If the assisted person P operating the marine vessel 75 reduces the velocity, the assistance system 1 determines an alleviation of the detected conflict between low visibility and high cruising velocity of the marine vessel 75. The assistance system 1 amends the tactile stimulation 18 to the event of the low visibility in the environment. As the lower part of FIG. 19 illustrates, another potential issue to which the marine vessel 75 might be more susceptible while cruising with the reduced velocity 111, e.g. the effect of the lateral waves 113 arises, and the assistance system 1 generates and communicates this to the assisted person P via the tactile representation 112 output in the tactile stimulation 18.

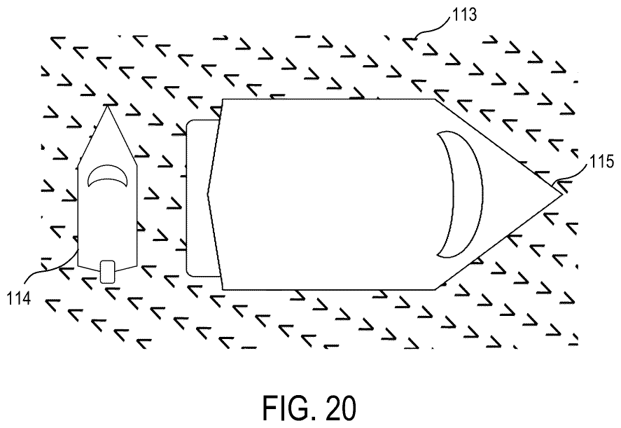

FIG. 20 illustrates a docking scenario of small boat 114 docking at a platform arranged at the stern of a large marine vessel 115 in a maritime scenario involving waves 113 illustrating further implementation details.

Generally, in a marine environment target locations may be mobile to varying degrees. In the example of FIG. 20, when docking with a small boat 114, (corresponding to the marine vessel 75) at a platform at the stern of a larger (another) vessel 115, the other vessel 115 may be moving due to its own propulsion or due to external forces exerted, e.g., by marine currents 61, waves 113, or wind 100. With each movement of the larger vessel 115, a future target state of the small boat 114 changes, resulting in a corresponding location change of the target state. The assistance system 1 of an embodiment that assists the person P operating the small boat 114 maps determined location changes of the target state onto changes in tactile stimuli of the tactile stimulation 18 output to the assisted person P, which require no visual attention. The assisted person P may focus her vision entirely on monitoring the environment instead of switching between a visual assistance presented on a display screen and a personal visual monitoring of the current scenario.

The scenario of FIG. 20 is particularly advantageous in maritime applications such as transfer of pilots for navigation and police or custom officials to vessels.

Alternative application examples of tasks that involve moving targets to be taken into regard by the assistance system 1 in the maritime environment include, e.g., wildlife-monitoring, whale watching, or fishing.

Elements in the environment may be unambiguously encoded in the tactile stimulation 18 for some embodiments. High-resolution tactile interface devices 50 that are capable of varying, e.g., stimulus location and stimulus patterns in multiple dimensions support an unambiguous encoding of the spatial information for communication to the assisted person P.

Alternatively, a combination of the tactile stimulation 18 and output with other modalities, such as vision provided by display devices can be advantageous in some embodiments. Vision is a dominant sense with fast and highly accurate recognition capabilities. Even in situations with an otherwise occupied visual modality, a quick glance to the right direction may suffice in acquiring recent information about an event of interest and of relevance in the situation. Some embodiments may utilize a combination of tactile stimulation 18 to quickly inform or alert the assisted person P about existence and direction of an element of relevance in the environment, and a simultaneous display of information on the same element on a visual display. The assisted person P may then optionally glance at the display screen to learn more about, e.g., the identity of an element of relevance in cases of ambiguity or as a form of multimodal facilitation. Multimodal facilitation benefits from the phenomenon that perception via one human sense can facilitate detection via another human sense.

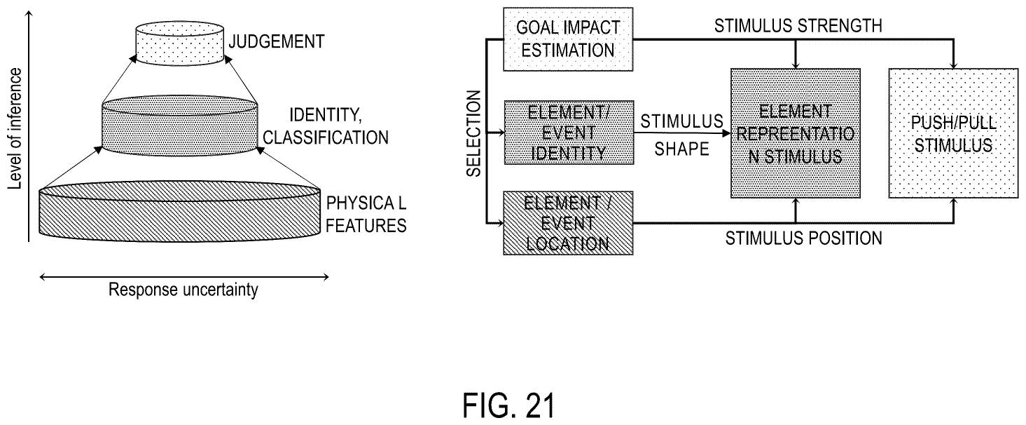

FIG. 21 illustrates inference levels and response states in a tactile interface device useful for implementing an embodiment of the assistance system 1 referring to specific implementation details.

The higher the level of inference by which a stimulation is driven, the lower the uncertainty about how to respond to the stimulation. An identity-encoding stimulation preserves mid-level inference information that allows humans to make their own response judgements that take knowledge about mid-level classes into account.

Push stimulation or pull stimulation discard mid-level inferences and hence reduce the space for consistent stimulation responses.

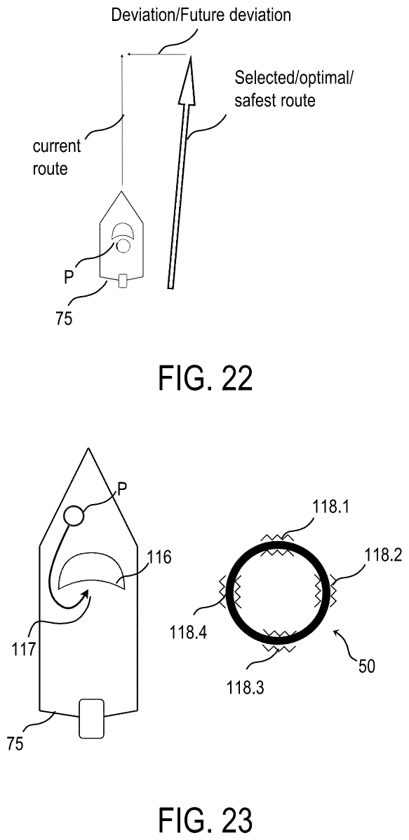

FIG. 22 depicts an exemplary scenario of route navigation with the assistance system illustrating specific implementation details.

The assistance system 1 operating in the navigation assistance mode or, in other terms, performing a navigation assistance function, determines a spatial deviation of a current position of the marine vessel 75 from an intended route for the marine vessel 75. The assistance system 1 generates control information for controlling the tactile interface device 50 to output a tactile stimulation 18 to the assisted person P that encodes the determined deviation from the intended route.

The assistance system 1 may output a tactile stimulation 18 to the assisted person P that indicates the determined deviation from the intended route by providing a tactile stimulus to the assisted person P that appears to come from the direction, where the intended route is from the location of the assisted person P. In this example, the tactile stimulation 18 provides a tactile representation to the assisted person P that encodes a movement direction error of the marine vessel 75 with the assisted person P on board.

Alternatively, or additionally, the assistance system 1 may encode in the tactile representation output via the tactile interface device 50 in the tactile stimulation 18, a predicted deviation from the intended route. For instance, when the assistance system 1 determines a direction of travel to be correct given the current physical trajectory of the marine vessel 75, the assistance system 1 may predict the marine vessel 75 to deviate from the intended route in the future due to predicted future wind or current conditions along the intended route. The information on predicted future wind or current conditions along the intended route may not be perceivable for the assisted person P at the current time. The assistance system 1 may control the tactile interface device 50 to output a tactile stimulation 18 that communicates the information by proposing a course change for the marine vessel 75 that the assisted person P may put into perspective when the environmental elements included in the information on the predicted future wind or current conditions along the intended route underlying the proposed course change are experienced.

The encoding in the tactile stimulation 18 may use either push or pull analogies. For example, an activation of tactile actuators 17 arranged on a side of the tactile interface device 50 corresponding to the determined or predicted deviation drift origin represents a push analogy, due to apparently pushing the assisted person P. The alternative encoding of the information in a tactile stimulation 18 that includes activating tactile actuators 17 arranged on a side of the tactile interface device 50 opposite to the determined or predicted deviation drift origin a pull analogy, due to apparently pulling the assisted person P.

FIG. 23 depicts an exemplary scenario of a general alert stimulation in the assistance system illustrating specific implementation details. The right part of FIG. 18 shows an illustration of a general alerting clockwise circular tactile stimulation pattern in a tactile representation 118 with four stimulus locations 118.1, 118.2, 118.3, and 118.4 successively active (vibrating or applying pressure) in the output tactile stimulation 18, but not issuing a selective direction information to the assisted person P.

A general alerting stimulation by the tactile interface device 50 may be distinguished from other tactile stimulation 18 by using specific tactile patterns, frequencies, or stimulation strengths for the tactile representation of the tactile stimulation 18. A selective direction encoding is not necessary for providing general alerts to the assisted person P via the tactile interface device 50. The assistance system 1 may use alerting stimulation patterns augmented by tactile features in the tactile stimulation 18 in cases in which communicating directions are beneficial. Some embodiments of the assistance system 1 may use such direction encoding alerting patterns in the tactile stimulation 18 to support the assisted person P via providing walking direction guidance on or within the marine vessel 75. The left part of FIG. 23 illustrates this specific example by not only alerting the assisted person P currently present on the forecastle of the marine vessel 75, but also providing guidance for a movement 117 of the assisted person P towards the cockpit 116 of the marine vessel 75, where a determined event in the environment or on board of the marine vessel 75 may require attention of the assisted person P.

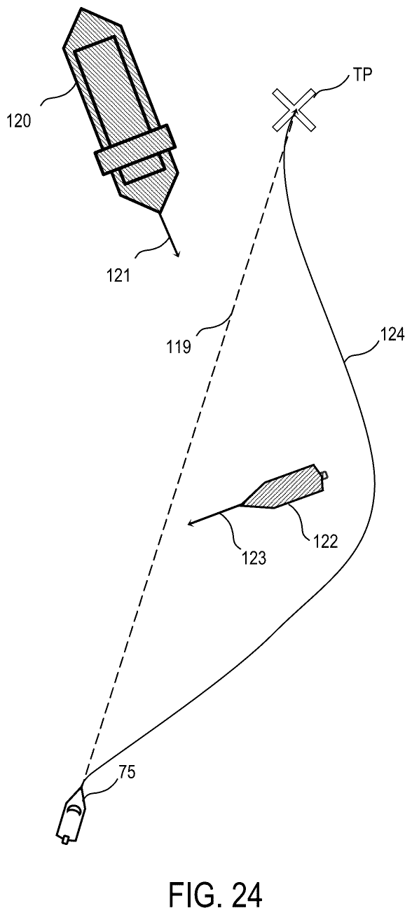

FIG. 24 depicts an exemplary scenario of integrating AIS system signals in an embodiment of the assistance system 1.

The automatic identification system (AIS) is an automatic ship tracking system that uses transceivers on board of ships and is uses for vessel traffic services (VTS). AIS information includes information on unique identity of a ship, its position course and velocity for display on a screen and supports marine authorities as well as officer on watch on ships to track and monitor ship movements.

In the scenario of FIG. 24, the marine vessel 75 under control of the assisted person P is moving along an original planned route 119 towards the target point TP. A first ship 120 on first colliding course 121 with the marine vessel 75 and a second ship 122 on a second colliding course 123 are in the environment of the marine vessel 75. The marine vessel 75, in particular the assistance system 1 supporting the person P wearing the tactile interface device 50 obtains from the AIS information on the first and second ships 120, 122, their respective courses 121, 123, and their velocities. The assistance system 1 evaluates the information obtained from the AIS, predicts possible collision events involving the marine vessel 75, the first ship 120, and the second ship 122, and uses the information on the movement of the marine vessel 75, the first ship 120, and the second ship 122 to determine an updated intended route 119 for mitigating the risks of collisions involving the marine vessel 75. The assistance system 1 controls the tactile interface device 50 to output a tactile stimulation 18 to the assisted person P, that the assisted person P interprets as a push from the current position and course of the marine vessel 75 on the original intended route 116 onto the updated intended route 124 and along the updated intended route 124 towards the target point TP.

The collision risk in the scenario of FIG. 24 is thereby mitigated.

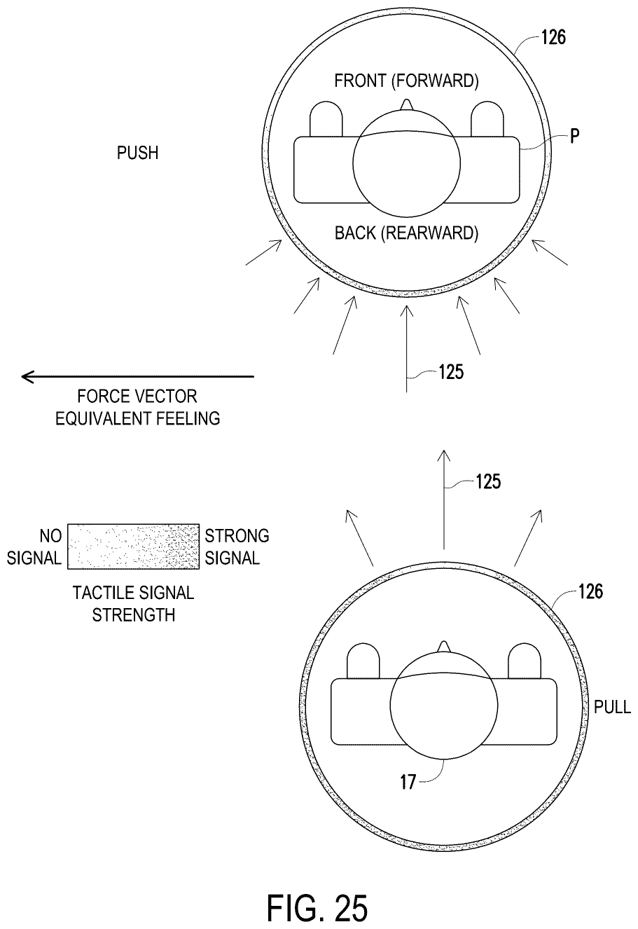

FIG. 25 illustrates alternate tactile stimulation modalities using either a pushing mode (push mode) or a pulling mode (pull mode) for a tactile interface device 50 of the assistance system 1.

When operating in the push mode, the tactile interface 50 applies the tactile stimulation 18 such that tactile stimuli of the tactile stimulation 18 are applied to an opposite side of the assisted person P as the assisted person should move. For example, if the assistance system determines that the assisted person should move forward into a direction to which the assisted person P is currently facing, the tactile stimulation 18 includes tactile stimuli that are applied at the back of the assisted person P to indicate forward movement. The upper portion of FIG. 25 illustrates the tactile interface 50 operating in the push mode towards the forward direction of the assisted person P. The length of a force vector indicates a strength of the respective stimulus and corresponds to the perceived strength or feeling of force by the assisted person P. Similarly, a shading of the corresponding section on the circular representation 126 indicates a strength of the tactile stimulation 18 of the actuator arrangement around the torso of the assisted person P. The darker the shading of the circular representation 126, the stronger the strength of the tactile stimulation 18 is in the corresponding direction relative to the assisted person P.

When operating in the pull mode, the tactile stimulation 18 is applied at an area of the assisted person P, which faces to the direction relative to the assisted person P, into which the assisted person P is intended to move. The assisted person P is intended to follow the signal, which feels like the assisted person P being pulled. In the push mode, the tactile interface 50 applies the tactile stimulation 18 such that tactile stimuli of the tactile stimulation 18 are applied to an area on the same side of the assisted person P as the assistance system 1 determines the assisted person P should move. For example, if the assistance system determines that the assisted person should move forward into a direction to which the assisted person P is currently facing, the tactile stimulation 18 includes tactile stimuli that are applied at the front of the assisted person P to indicate a forward movement. The lower portion of FIG. 25 illustrates the tactile interface 50 operating in the pull mode towards the forward direction of the assisted person P. As in the push mode, in the pull mode illustrated in FIG. 25, a length of a force vector indicates a strength of the respective stimulus and corresponds to the perceived strength or feeling of force by the assisted person P. Similarly, a shading of the corresponding section on the circular representation 126 indicates the actuator arrangement around the torso of the assisted person P.

All features described above or features shown in the figures can be combined with each other in any advantageous manner within the scope of the disclosure. In the detailed discussion of embodiments, numerous specific details were presented for providing a thorough understanding of the invention defined in the claims. It is evident that putting the claimed invention into practice is possible without including all the specific details.

In the specification and the claims, the expression “at least one of A and B” may replace the expression “A and/or B” and vice versa due to being used with the same meaning. The expression “A and/or B” means “A, or B, or A and B”.

The above explained embodiments described a plurality of different modes and how a communication to the assisted person can be achieved. However, it is advantageous that a plurality of modes may utilize a consistent encoding that does not require a switch in the mental model of the operator. For example, this could be achieved when framing a plurality of issues as influences on the navigation route (or path) and then using some encoding of spatial or directional error relative to the preferred target route. The tactile stimuli encodes deviations from a preferred path. Bad weather, obstacles, etc. shape that path. A man over board adds a new destination/waypoint that needs to be resolved before being allowed to continue, etc. When referring to FIG. 21, such path deviation stimuli would be “judgement level” stimuli, which do not necessarily have to encode identity. Nevertheless, path deviation signals which additionally encode identity of a cause for the error are also feasible. In an example, stimulus direction and strength are used to indicate magnitude and direction of a deviation and use specific patterns to convey identity information (i.e., why the current trajectory is a deviation from the preferred route). For embodiments with such encoding combinations the mode switch could then consist of a context-dependent pattern selection. During a man-over-boat situation the navigation target changes and returns to the previous state when the problem is resolved. As bad weather approaches, the preferred route changes.

In case of rerouting, for example caused by bad weather, information can be communicated to the assisted person using at least the following: 1. Upon rerouting, the tactile signal conveys the reason for the rerouting and its origin (direction) is created. 2. When deviating from a preferred route, an error-encoding stimulus that additionally conveys the respective reason for the local shape of the route is generated.

What is claimed is:

1. A computer-implemented method for assisting a person in operating a marine vessel, the method comprising:
obtaining information on an environment of the marine vessel;
determining, from the obtained information on the environment, at least one event, state or entity;
determining a relative position of the determined at least one event, state or entity, relative to the marine vessel,
determining first spatial signaling information based on the relative position;
acquiring relative position information and relative orientation information of a tactile interface device to the marine vessel, wherein the tactile interface device comprises a plurality of actuators arranged in contact with the assisted person;
computing second spatial signaling information by converting the first spatial signaling information based on the relative position information and the relative orientation information of the tactile interface device;
generating control information for the tactile interface device and outputting, via the tactile interface device, the computed second spatial signaling information to the assisted person.

2. The computer-implemented method according to claim 1, wherein the determined at least one entity includes at least one of
another marine vessel, a person in a water or below a sea level, a moving wave, a wind gust, a marine current, a tidal current, and a static or moving object in the water, above or below a water-level.

3. The computer-implemented method according to claim 1, wherein the determined at least one event includes at least one of
a predicted collision with a determined object, a predicted deviation from a planned trajectory of the marine vessel, a determined state of the marine vessel or another marine vessel.

4. The computer-implemented method according to claim 1, wherein the determined at least one state includes at least one of
a predicted deviation from a planned trajectory of the marine vessel, a determined state of the marine vessel or another marine vessel.

5. The computer-implemented method according to claim 4, wherein the method includes
determining the state of the marine vessel and at least one other vessel based on right-of-way rules for marine traffic or based on marine customs.

6. The computer-implemented method according to claim 4, wherein the method includes
determining contextual information for determining the state of the marine vessel or another vessel, wherein the determined contextual information includes at least one of weather information, vessel-related information, topography-related information, information on topography of sea floor, information on maritime infrastructure, and event related information.

7. The computer-implemented method according to claim 1, wherein
outputting, via the tactile interface device, the computed second spatial signaling information to the assisted person including communicating a direction relative to the assisted person to the determined at least one event, state or entity via a tactile stimulus position on a body of the assisted person.

8. The computer-implemented method according to claim 1, wherein
outputting, via the tactile interface device, the computed second spatial signaling information to the assisted person including communicating an encoded tactile representation of the determined at least one event, state or entity in a tactile stimuli output to a body of the assisted person.

9. The computer-implemented method according to claim 8, wherein
the encoded tactile representation includes in at least one first tactile characteristic of the tactile stimuli a predicted impact and in at least one second characteristic of the output tactile stimuli the encoded determined at least one event, state or entity.

10. The computer-implemented method according to claim 1, wherein the method comprises
determining at least two different events, states or entities from the obtained information on the environment; and
automatically selecting based on at least one selection criterion at least one of the at least two different events, states or entities for communication to the assisted person.

11. The computer-implemented method according to claim 10, wherein
the at least one selection criterion includes the assisted person boarding the marine vessel, and the method comprises:
in case of determining that the assisted person boards the marine vessel, automatically switching from communicating via the tactile interface device the second spatial information including a route or direction towards the marine vessel to communicating the selected events, states or objects different from the marine vessel.

12. The computer-implemented method according to claim 10, wherein
the at least one selection criterion includes the assisted person leaving the marine vessel, and the method comprises:
in case of determining that the assisted person leaves the marine vessel, automatically switching from communicating via the tactile interface device the selected events, states or objects different from the marine vessel to communicating to the assisted person the second spatial information including a direction towards the marine vessel.

13. The computer-implemented method according to claim 10, wherein
automatically selecting based on at least one selection criterion includes selecting between different modes of assistance, and
the different modes include at least two of a general alerting mode, a route navigation mode, a bad weather avoidance mode, a disturbing-forces assistance mode, man or object overboard mode, a right-of-way assistance mode, a navigation channel guidance mode, and a docking mode, and
at least one of the modes of assistance is active at a given time.

14. The computer-implemented method according to claim 10, wherein
the tactile interface device arranges a plurality of tactile actuators in a grid extending in a vertical direction in addition to two horizontal directions when worn by the assisted person, and
the method comprises, in the step of computing the second spatial signaling information by converting the first spatial signaling information based on the relative orientation information and the relative position information of the tactile interface device, compensating for at least one of a roll angle, pitch angle and yaw angle of the marine vessel.

15. A system for assisting a person in operating a marine vessel, the system comprising:
at least one sensor configured to obtain information on an environment of the marine vessel;
a processor configured to determine, from the obtained information on the environment, at least one event, state or entity;
a tactile interface device comprising a plurality of actuators arranged in contact with the assisted person;
wherein the processor is configured to determine a relative position of the determined at least one event, state or entity with respect to the marine vessel, to determine first spatial signaling information based on the relative position, and to acquire relative position information and orientation information of the tactile interface device, relative to the marine vessel, and
wherein the processor is further configured to compute second spatial signaling information by converting the first spatial signaling information based on the relative position and the relative orientation of the tactile interface device; and
a controller configured to generate control information for the tactile interface device and to output, via the tactile interface device, the computed second spatial signaling information to the assisted person.

16. A tactile interface device for communicating information to a person in a maritime environment, wherein the interface device comprises
a communication interface configured to obtain spatial signaling information;
a controller configured to generate control information based on the obtained spatial signaling information; and
a plurality of tactile actuators provided to be in contact with a body of the assisted person and configured to output the spatial signaling information to the assisted person based on the generated control information.

17. The tactile interface device according to claim 16, wherein
the tactile interface device is a wearable device or attachable to the wearable device.

18. The tactile interface device according to claim 17, wherein
the wearable device is a personal flotation device, a life jacket or a life preserver.

19. The tactile interface device according to claim 17, wherein
the wearable device is a belt.

20. The tactile interface device according to claim 16, wherein
the tactile interface device is integrated into at least one of a seat of the marine vessel.

21. The tactile interface device according to claim 16, wherein
the plurality of tactile actuators are arranged in a grid extending in a vertical direction in addition to two horizontal directions when worn by the assisted person.
